(19) United States
(12) Patent Application Publication
(10) Pub. No.: US 2008/0106786 A1
(43) Pub. Date: May 8, 2008

(54) Examination method and examination apparatus

(76) Inventors: Nobuyuki Nagasawa, Hino-shi (JP); Yasunori Makara, Hino-shi (JP); Hiroya Fukuyama, Machida-shi (JP); Yoshihisa Tanikawa, Chuo-ku (JP)

Correspondence Address: John C. Altmiller, Esq.;Kenyon & Kenyon, Suite 700, 1500 K Street, N.W., Washington, DC, 20005-1257, US

(21) Appl. No.: 12/001,547

(22) Filed: Dec. 11, 2007

Related U.S. Application Data
(62) Division of application No. 11/651,680, filed on Jan. 9, 2007.
Application No. 11/651,680 is a division of application No. 11/138,506, filed on May 27, 2005.

(30) Foreign Application Priority Data
May 28, 2004 (JP) 2004-159936
Sep. 3, 2004 (JP) 2004-257116
Jan. 11, 2005 (JP) 2005-004069

(51) Int. Cl. G02B 21/26

(52) U.S. Cl. 359/379

(57) ABSTRACT

An easily viewable examination image in which blurring occurring in an image is reduced without operating an examination optical system in real time matching the motion of a specimen is obtained. There is provided an examination method comprising, prior to examining an examination site of a specimen, acquiring an image of the specimen surface of an examination region including the examination site, over a predetermined time range; extracting a plurality of feature points by processing the acquired image of the specimen surface; calculating a motion trajectory for each of the extracted feature points over the time range; and disposing an optical axis of an examination optical system at a position where the motion trajectory of a feature point disposed in the examination site is minimized.

### CROSS-REFERENCE TO RELATED APPLICATIONS

This application is a divisional application of U.S. patent application Ser. No. 11/138,506 filed on May 27, 2005, which in turn claimed priority based on Japanese Patent Application Nos. 2004-159936, 2004-257116, and 2005-004069, the contents of which are incorporated herein by reference.

### BACKGROUND OF THE INVENTION

1. Field of the Invention

The present invention relates to an examination method and an examination apparatus for carrying out in-vivo examination of a specimen such as a living organism.

2. Description of Related Art

In recent years, visualization of ion concentration, membrane potential, and so on has been carried out with fluorescence probes using fluorescence microscopes; for example, examination of the biological function of nerve cells and so on, and particularly the examination of dynamic motion, has been carried out.

As one such system for examining dynamic motion, a microscope photography apparatus is known (see, for example, Japanese Unexamined Patent Application Publication No. 2000-275539).

Such a conventional microscope photography apparatus takes-pictures according to the dynamic motion of the living organism serving as a specimen. Since it selectively takes pictures in stationary, in-focus states during the dynamic motion of the specimen while keeping the focal length of a camera constant, there is a problem in that the acquired images are choppy, and in particular, it is not possible to examine the condition of the specimen in the moving state.

Furthermore, when actually examining the moving state of a specimen in-vivo, since the specimen moves three-dimensionally due to pulsation such as respiratory action, a heartbeat, and so on, image blurring occurs, which is a problem. Image blurring occurs particularly when the specimen moves in a direction intersecting the optical axis of the camera. However, moving the optical axis of the examination optical system including the camera in real time to match the motion of the specimen makes the apparatus more complex, and in particular, performing magnified examination of the specimen with the microscope apparatus becomes impractical.

### BRIEF SUMMARY OF THE INVENTION

The present invention has been conceived in light of the circumstances described above, and it is an object thereof to provide an examination method and an examination apparatus which can acquire clearly visible examination images in which the blurring of the images is reduced without moving an examination optical system in real time to match the motion of a specimen.

In order to achieve the objects mentioned above, the present invention provides the following solutions.

A first aspect of the invention is an examination method comprising, prior to examining an examination site with an examination optical system, acquiring an image of the specimen surface of an examination region including the examination site, over a predetermined time range; extracting a plurality of feature points by processing the acquired image of the specimen surface; calculating a motion trajectory for each of the extracted feature points over the time range; and disposing an optical axis of an examination optical system at a position where the motion trajectory of a feature point disposed in the examination site is minimized.

According to this aspect, prior to examination with the examination optical system, the optical axis of the examination optical system is disposed at a position where the motion trajectory, over a predetermined time range, of a feature point located in the examination site in the image of the specimen surface is shortest. Therefore, during examination with the examination optical system, it is possible to set the relative positional relationship between the specimen and the examination optical system so that the examination site of the specimen is moved in the optical-axis direction of the examination optical system. The depth of field of the examination optical system is increased relative to the motion of the specimen in the optical-axis direction of the examination optical system, and by employing autofocus, it is possible to maintain the focused state. Accordingly, blurring of the images acquired by the examination optical system is reduced, and it is thus possible to facilitate examination of the examination site.

Furthermore, a second aspect of the present invention is an examination apparatus comprising an image-acquisition unit that acquires images, over a predetermined time range, of a specimen surface of an examination region including an examination site; a feature-point extraction unit that processes an image of the specimen surface acquired by the image-acquisition unit to extract a plurality of feature points; a motion-trajectory calculating unit that calculates a motion-trajectory of each extracted feature point over the time range; an examination optical system for examining the specimen surface; an optical-axis direction adjusting unit that changes the direction of an optical axis of the examination optical system with respect to the specimen surface; and a control unit that controls the operation of the optical-axis direction adjusting unit, wherein, prior to examination with the examination optical system, the control unit controls the optical-axis direction adjusting unit so that the optical axis of the examination optical system is disposed at a position where the motion trajectory of the feature point located in the examination site, which is calculated by the motion-trajectory calculating unit, is minimized.

According to this aspect, the images of the specimen surface acquired by the imaging unit over a predetermined time range are processed by operating the feature-point extraction unit to extract a plurality of feature points from the images of the specimen surface. The motion-trajectory calculation unit calculates the motion trajectory of each feature point by tracking the motion of the extracted feature points over a predetermined time range. Since the motion trajectories indicate the amount of movement of each feature point in a direction orthogonal to the optical axis of the imaging unit, if the optical axis of the imaging unit changes relative to the specimen, the length of the motion trajectory of each feature point changes. Thus, by operating the optical-axis direction adjusting unit so that the optical axis of the examination optical system is disposed at a position where the motion trajectory of a feature point located at the examination site, which was calculated by motion-trajectory calculating unit, becomes shortest, the examination site is mainly shifted only in the direction of the optical axis of the examination optical system by operating the control unit. In this state, it is possible to acquire images with little blurring by carrying out examination with the examination optical system.

Furthermore, a third aspect of the present invention is an examination apparatus comprising an examination optical system including an image-acquisition unit that acquires images, over a predetermined time range, of a specimen surface in an examination region including an examination site; a feature-point extraction unit that processes images of the specimen surface acquired by the image-acquisition unit to extract a plurality of feature points; a motion-trajectory calculating unit that calculates a motion trajectory of each extracted feature point over the time range; and an image display unit that superimposes and displays the image of the specimen surface acquired by the image-acquisition unit and, for each feature point, the motion trajectory calculated by the motion-trajectory calculating unit.

According to this aspect, images of the specimen surface are acquired by operating the image-acquisition unit of the examination optical system, and by operating the feature-point extraction unit, the acquired images of the specimen surface are processed to extract a plurality of feature points, and a motion trajectory for each feature point, over a predetermined time range, is calculated by operating the motion-trajectory calculating unit. Since the image display unit superimposes the image of the specimen surface acquired by the image-acquisition unit and the motion trajectories of the feature points, which are calculated by the motion-trajectory calculating unit, the observer can check, on the image display unit, by what amount and in which direction the examination site has moved. Then, after moving the optical axis of the examination optical system so that the motion trajectory of the examination site becomes smaller, images of the examination site having reduced blurring can be acquired by carrying out examination with the examination optical system.

According to the present invention, prior to carrying out examination with an examination optical system, since the examination site of the specimen is set at a position where it does not move in a direction intersecting the optical axis of the examination optical system, an advantage is provided in that it is possible to acquire clearly visible examination images in which the incidence of blurring is reduced, without having to move the examination optical system in real time to match the motion of the specimen.

### BRIEF DESCRIPTION OF THE SEVERAL VIEWS OF THE DRAWINGS

FIG. 1 is a front elevation showing an examination apparatus according to a first embodiment of the present invention.

FIG. 2 is a side view showing the examination apparatus in FIG. 1.

FIG. 3 is an explanatory view of an orientation modifying procedure of a measurement head in the examination apparatus in FIG. 1, showing extracted feature points in the image.

FIG. 4 is an explanatory view of an orientation modifying procedure of the measurement head in the examination apparatus in FIG. 1, showing displacement of the feature points between two images.

FIG. 5 is a diagram showing the motion trajectory before modifying the orientation, in which the motion of the feature points in FIG. 4 is connected.

FIG. 6 is a diagram showing the motion trajectory after modifying the orientation.

FIG. 7 is a front elevation showing an examination apparatus according to a second embodiment of the present invention.

FIG. 8 is a block diagram for explaining an image processing unit in the examination apparatus in FIG. 7.

FIG. 9 is an overall schematic diagram showing a microscope examination system according to a third embodiment of the present invention.

FIG. 10 is a perspective view showing the relationship between an objective unit and a stabilizer in the microscope examination system of FIG. 9.

FIG. 11 is a bottom plan view showing the configuration of a distal portion of the stabilizer in FIG. 10.

FIGS. 12A to 12C are diagrams for explaining suppression of the dynamic motion of the specimen by the stabilizer in FIG. 10.

FIG. 13 is a bottom plan view showing a first modification of the stabilizer in FIG. 10.

FIG. 14 is a longitudinal sectional view showing a second modification of the stabilizer in FIG. 10.

FIG. 15 is a longitudinal sectional view showing a third modification of the stabilizer in FIG. 10.

FIG. 16 is a longitudinal sectional view showing a fourth modification of the stabilizer in FIG. 10.

FIG. 17 is a longitudinal sectional view showing the relationship between an objective unit and a stabilizer of the microscope examination system according to a fourth embodiment of the present invention.

FIG. 18 is a longitudinal sectional view showing a first modification of the stabilizer in FIG. 17.

FIG. 19 is a longitudinal sectional view showing a second modification of the stabilizer in FIG. 17.

FIG. 20 is an overall structural diagram showing a microscope examination system according to a fifth embodiment of the present invention.

FIG. 21 is a perspective view showing the relationship between an objective unit and a stabilizer in the microscope examination system in FIG. 20.

FIG. 22 is a bottom plan view showing a suction surface of a suction pad of the stabilizer in FIG. 21.

FIG. 23 is an overall structural diagram showing a microscope examination system according to a sixth embodiment of the present invention.

FIG. 24 is a block diagram showing one example of a focus signal based on the displacement of the stabilizer of the microscope examination system in FIG. 23.

FIG. 25 is an overall structural diagram showing a microscope examination system according to a seventh embodiment of the present invention.

FIG. 26 is an overall structural diagram showing a microscope examination system according to an eighth embodiment of the present invention.

FIG. 27 is a diagram for explaining the operation of an examination-position control apparatus in FIG. 26.

### DETAILED DESCRIPTION OF THE INVENTION

### First Embodiment

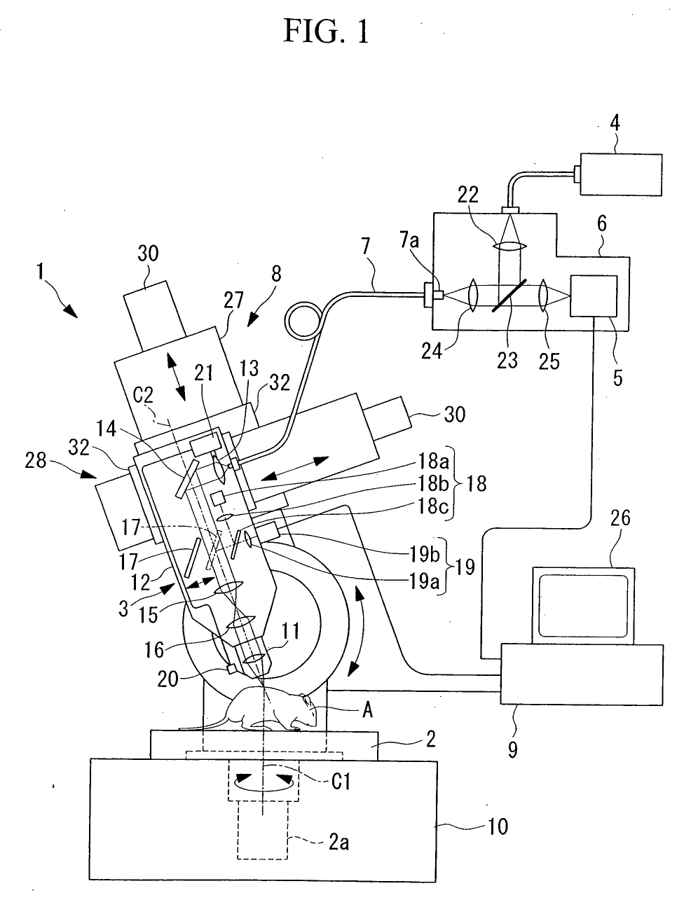

An examination apparatus and examination method according to a first embodiment of the present invention will be described below with reference to FIGS. 1 to 6.

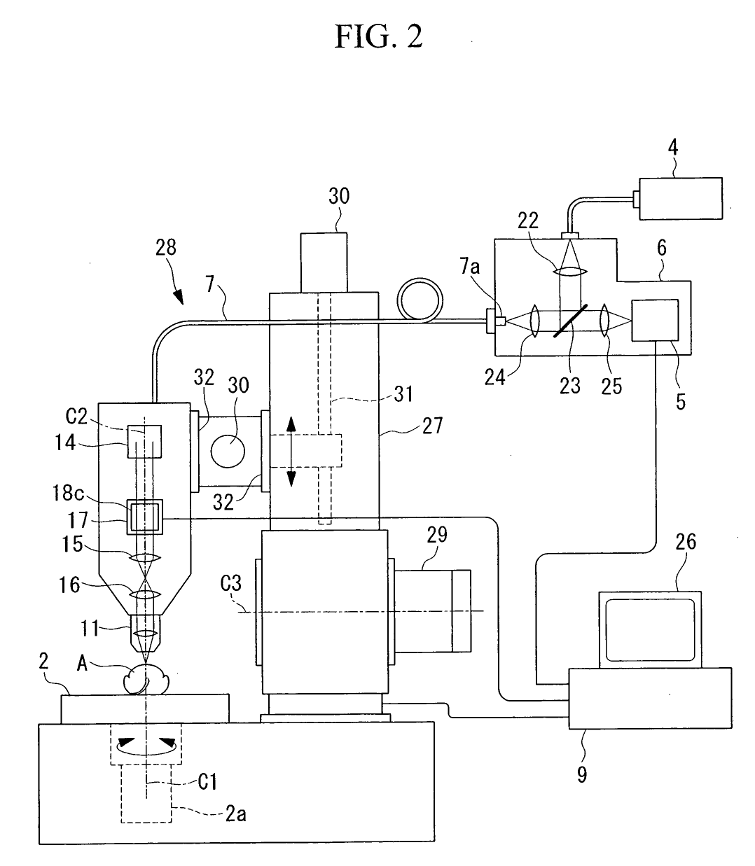

As shown in FIGS. 1 and 2, an examination apparatus 1 according to this embodiment includes a stage 2 for mounting a living organism A as the object to be examined, a measurement head 3 disposed opposite the stage 2, an optical unit 6 having a laser light source 4 and an optical detector 5, an optical fiber 7 that connects the measurement head 3 and the optical unit 6, an orientation adjusting mechanism 8 that supports the measurement head 3 in such a manner that the orientation thereof can be adjusted, and a control device 9 that controls the operation of the orientation adjusting mechanism 8.

The stage 2 includes a stage rotating mechanism 2a that rotates the stage 2 about a vertical axis C1 relative to a base 10. Fixing the measurement head 3 and operating the stage rotating mechanism 2a allows the living organism A to be examined from different angular directions around the entire circumference.

The measurement head 3 includes an objective optical system 11 disposed at the end facing the stage 2, and a collimator optical system 13, an optical scanning unit 14, a pupil-projection optical system 15, and an imaging optical system 16, which are disposed inside a casing 12 to which the objective optical system 11 is attached. The collimator optical system 13 converts the laser beam transmitted by the optical fiber 7 into a collimated beam. Although shown only schematically in the figure, the optical scanning unit 14 enables the collimated beam from the collimator optical system 13 to be two-dimensionally scanned by, for example, rocking two galvano mirrors about two respective orthogonal axes.

The pupil-projection optical system 15 focuses the laser beam scanned by the optical scanning unit 14 to form an intermediate image. The imaging optical system 16 then collects the laser light forming the intermediate image to convert it into a collimated beam.

The objective optical system 11 is disposed close to the living organism A mounted on the stage 2 and focuses the collimated beam from the image forming optical system 16 to re-image it at a specific image position on the surface of the living organism A or in the internal structure of the living organism A.

Also provided in the measurement head 3 are a mirror 17 that is disposed so as to be insertable in and removable from the optical path of return light that returns from the pupil-projection optical system 15 towards the optical scanning unit 14, an illumination optical system 18 that makes illumination light from the mirror 17 incident along an optical axis C2 of the objective optical system 11 when the mirror 17 is inserted in the optical path, and an image-acquiring optical system 19 that acquires the return light from the living organism A, which is reflected by the mirror 17.

The illumination optical system 18 includes a light source 18a, such as an LED, a collimator lens 18b for converting the light emitted by the light source 18a into a collimated beam, and a half-mirror 18c that makes the collimated light from the light source 18a incident on the mirror 17. The image-acquiring optical system 19 includes a focusing lens 19a and a CCD camera 19b.

Also provided in the measurement head 3 are a distance sensor 20 that measures the distance to the surface of the living organism A and an autofocus mechanism 21 that moves the collimator optical system 13 in the optical-axis direction so as to adjust the focal position in response to the output from the distance sensor 20.

The optical unit 6 includes a collimator lens 22 that converts the laser beam emitted from the laser light source 4 into a collimated beam, a dichroic mirror 23 that reflects the laser-light and that allows return light returning to the optical unit 6 to pass therethrough, a focusing lens 24 that focuses the laser light reflected by the dichroic mirror 23 on an end 7a of the optical fiber 7, and a focusing lens 25 that focuses the return light passing through the dichroic mirror 23 onto the optical detector 5. The optical detector 5 is, for example, a photomultiplier tube. A monitor 26 is connected to the optical detector 5 via an image processing unit (not shown) in the control device 9, and acquired images are displayed on the monitor 26.

The optical fiber 7, connected to the optical unit 6 and the measurement head 3, transmits laser light coming from the optical unit 6 to introduce it into the measurement head 3, as well as transmitting the return light returning from the measurement head 3 to introduce it into the optical unit 6.

The orientation adjusting mechanism 8 includes, for example, a rotating arm 27 that can rotate about a horizontal axis C3 and a two-axis translation mechanism 28 that is attached to the end of the rotating arm 27 and that moves the measurement head 3 in a direction parallel to the longitudinal direction of the rotating arm 27 and in a direction orthogonal thereto.

The rotating arm 27 is disposed in such a manner that it can be swung in a vertical plane by a motor 29. The translation mechanism 28 includes, for example, a motor 30, a ball screw 31, and a slider 32 that is made to move in a straight line by the ball screw 31 and that is supported by a linear guide (not shown).

The control device 9 is connected to a CCD camera 19b and acquires at least two images with a predetermined time interval therebetween. When the initial image is acquired by the CCD camera 19b, first, the control device 9 extracts a plurality of feature points in the acquired image. The feature points are, for example, pixels in the image where the brightness level is higher than a predetermined value. If a plurality of such pixels higher than the predetermined value exist in a predetermined regions, the pixel with the highest brightness in that region is extracted as the feature point.

Next, the control device 9 calculates a motion trajectory for each feature point, showing how the extracted feature point in the image moves between the plurality of acquired images. If the number of images acquired by the CCD camera 19b is, for example, two, those two images are superimposed, and the motion trajectory is calculated by linking corresponding feature points. Then, the orientation adjusting mechanism 8 is moved so as to minimize the motion trajectory at an examination site in the image, for example, near the central position of the image.

An examination method using the examination apparatus 1 according to this embodiment, having such a configuration, will be described below.

When carrying out in-vivo examination of the living organism A, such as a small laboratory animal like a mouse and so forth, using the examination apparatus 1 according to this embodiment, first, in the measurement head 3, the mirror 17 is inserted between the optical scanning unit 14 and the pupil-projection optical system 15, light from the light source 18a is irradiated on the living organism A via the collimator lens 18b, the half-mirror 18c, the mirror 17, the pupil-projection optical system 15, the imaging optical system 16, and the objective lens 11, and return light returning from the living organism A via the objective lens 11, the imaging optical system 16, the pupil-projection optical system 15, the mirror 17, and the half-mirror 18c is focused by the focusing lens 19a and is acquired by the CCD camera 19b.

Image acquisition is carried out, for example, two times with a time delay therebetween. Then, based on the operation of the control device 9, corresponding feature points in the two images acquired by the CCD camera 19b are extracted and the motion trajectories thereof are calculated.

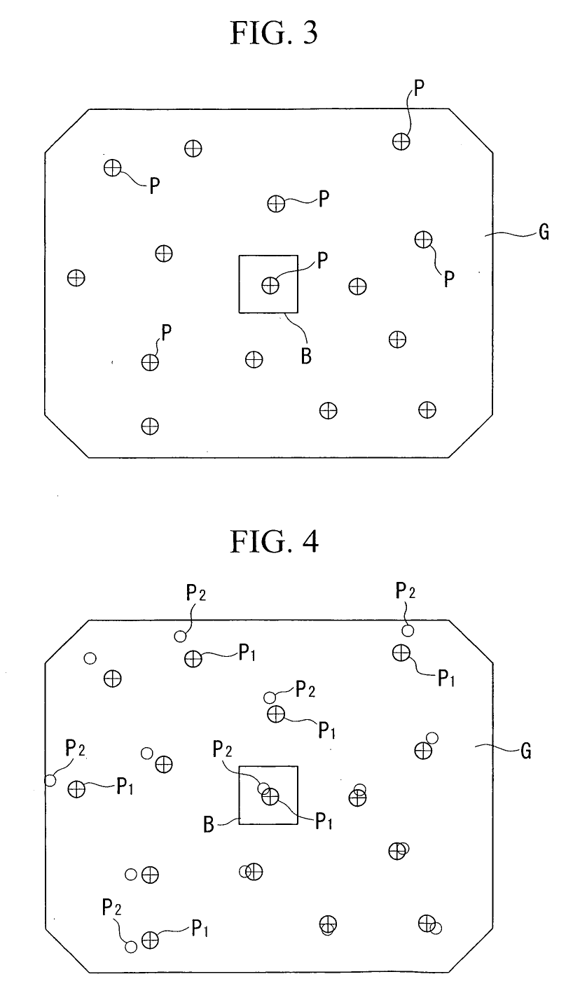

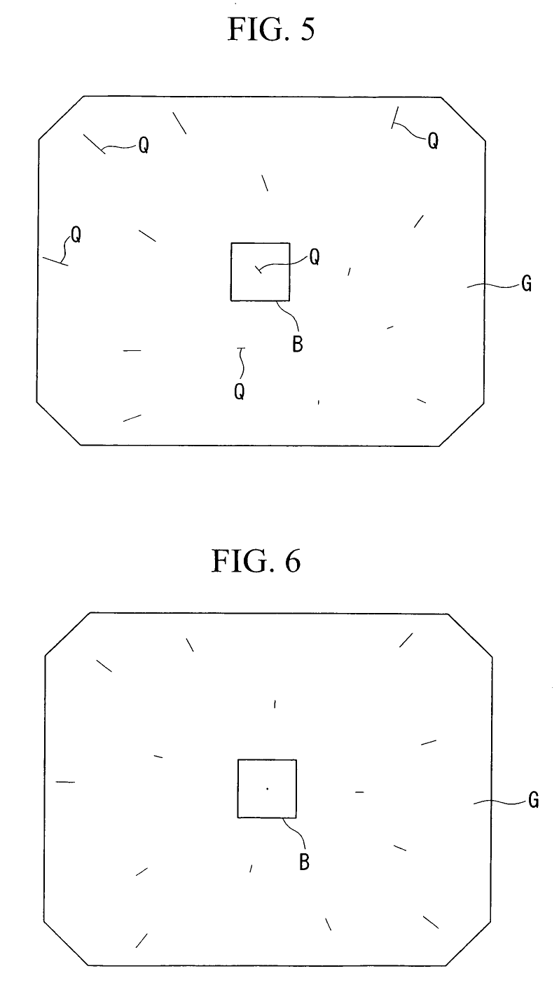

More concretely, pixels in two acquired images G having a brightness level greater than or equal to a predetermined value are extracted as feature points P, as shown in FIG. 3. Although the images G are shown here for simplifying the explanation, in this embodiment the calculation may be carried out without necessarily displaying the images on the monitor 26 during this process. In the figure, reference character B is an examination site. Then, the two images G are superimposed, as shown in FIG. 4, and a motion trajectory Q can be calculated by connecting the centers of the corresponding feature points P1 and P2, as shown in FIG. 5.

In FIG. 5, the motion trajectory Q in the examination site B is not the shortest motion trajectory in the image G, and so the living organism A is moving in a direction intersecting the optical axis C2 of the objective optical system 11 in the examination site B. If examination is carried out in this state, blurring occurs in the image of the examination site B, and therefore, the orientation adjusting mechanism 8 is operated so that, among the motion trajectories Q at the plurality of calculated feature points P, the motion trajectory Q at the examination site B is minimized.

Because the orientation adjusting mechanism 8 in this embodiment is formed of the rotating arm 27 and the two-axis translation mechanism 28, it is possible to arbitrarily adjust the angle of the optical axis C2 of the measurement head 3 within a plane parallel to the rotation plane of the rotating arm 27 while keeping the focal position of the objective optical system 11 fixed. Also, if it is desired to change the angle of the optical axis C2 of the measurement head 3 in directions other than this, the stage is rotated about the vertical axis by operating the stage rotating mechanism 2a. By doing so, it is possible to adjust the orientation of the optical axis C2 in any three-dimensional direction relative to the living organism A.

Thus, the orientation of the optical axis C2 of the measurement head 3 is adjusted so that the feature points P in the examination site B do not move, and the living organism A, which is displaced three-dimensionally, is displaced only in a direction parallel to the optical axis C2 of the measurement head 3 at this examination site B.

In this state, when the mirror 17 is removed from between the optical scanning unit 14 and the pupil-projection optical system 15 in the measurement head 3, and the optical unit 6 is operated to emit the laser beam from the laser light source 4, the emitted laser beam is focused via the collimator lens 22, the dichroic mirror 23, and the focusing lens 24 on the end 7a of the optical fiber 7 and is introduced thereto.

The laser beam introduced into the optical fiber 7 propagates through the optical fiber 7 to be guided to the measurement head 3, where it passes through the collimator optical system 13, the optical scanning unit 14, the pupil-projection optical system 15, the imaging optical system 16, and the objective optical system 11 in the measurement head 3 and is imaged at a specified image position inside the living organism A. Fluorescence generated in the internal structure of the living organism A due to irradiation with the laser beam returns via the objective optical system 11, the imaging optical system 16, the pupil-projection optical system 15, the optical scanning unit 14, and the collimator optical system 13, propagates in the optical fiber 7, and after being converted to collimated light by the focusing lens 24 in the optical unit 6, it passes through the dichroic mirror 23 and is made incident on the optical detector 5 by the focusing lens 25. The detection signal in the optical detector 5 is transmitted to the control device 9, where it is subjected to image processing to be displayed on the monitor 26 as a fluorescence image.

In such a case, with the examination apparatus 1 according to this embodiment, the direction of the optical axis C2 of the measurement head 3 relative to the living organism A is specified, using the control device 9, such that the examination site B is displaced only in the direction of the optical axis C2; therefore, it is possible to keep the direction of the optical axis C2 fixed during examination, which enables blur-free fluorescence images to be acquired. Also, simply by detecting the displacement of the surface of the living organism A in the direction of the optical axis C2 of the measurement head 3, based on the operation of the distance sensor 20, and operating the autofocus mechanism 21 in response thereto, it is possible to keep the examination site B in focus. Therefore, an advantage is provided in that it is possible to acquire sharp fluorescence images. When acquiring images of the interior of the living organism A using the confocal effect, it is possible to carry out confocal examination in a state where the focal position is fixed at a predetermined depth inside the living organism A by shifting the focal position of the objective optical system 11 from the surface position detected by the distance sensor 20.

In this way, with the examination apparatus 1 according to this embodiment, even if the examination site B of the living organism A, for example, a mouse, involves a periodic displacement such as respiratory motion, since the optical axis C2 of the measurement head 3 is fixed in the three-dimensional displacement direction of the examination site B thereof prior to examination, it is possible to reduce to a minimum blurring of the images G due to the displacement of the living organism A. Thus, according to the displacement of the examination site B in the direction of the optical axis C2, it is possible to maintain constant alignment between the focal position and the examination site B by means of the autofocus mechanism 21. As a result, sharp images G with no blurring or distortion are obtained.

In this embodiment, a structure that switches between the optical path to the CDD camera 19b and the optical path to the optical unit 6 by inserting and removing the mirror 17 is given as an example; however, the configuration is not limited to this. For example, when switching over to the CCD camera 19b, by simultaneously switching over to an objective optical system having a low magnification, during the aligning operation of the optical axis C2 of the measurement head 3, images of a relatively large region are acquired to confirm the motion trajectory Q thereof, and when carrying out examination using the optical unit 6, by switching over to the objective optical system 11 having a high magnification, it is possible to carry out magnified examination of the examination site B which is limited to a small region.

In the embodiment described above, the orientation adjusting mechanism 8, which is formed of the rotating arm 27 and the two-axis translation mechanism 28, and the stage 2, which can rotate about the vertical axis, are used as the mechanism for adjusting the orientation of the optical axis C2 of the measurement head 3; however, instead of this, it is possible to employ a manipulator having any other axial configuration.

Furthermore, although an example has been described in which the motion trajectory is calculated using two acquired images with a time delay therebetween, instead of this, it is also possible to calculate the motion trajectory using three or more images or moving images.

### Second Embodiment

Next, an examination apparatus and examination method according to a second embodiment of the present invention will be described below with reference to FIGS. 5 to 8.

In the description of this embodiment, parts having the same configuration as those in the examination apparatus 1 according to the first embodiment described above are assigned the same reference numerals, and a description thereof shall be omitted.

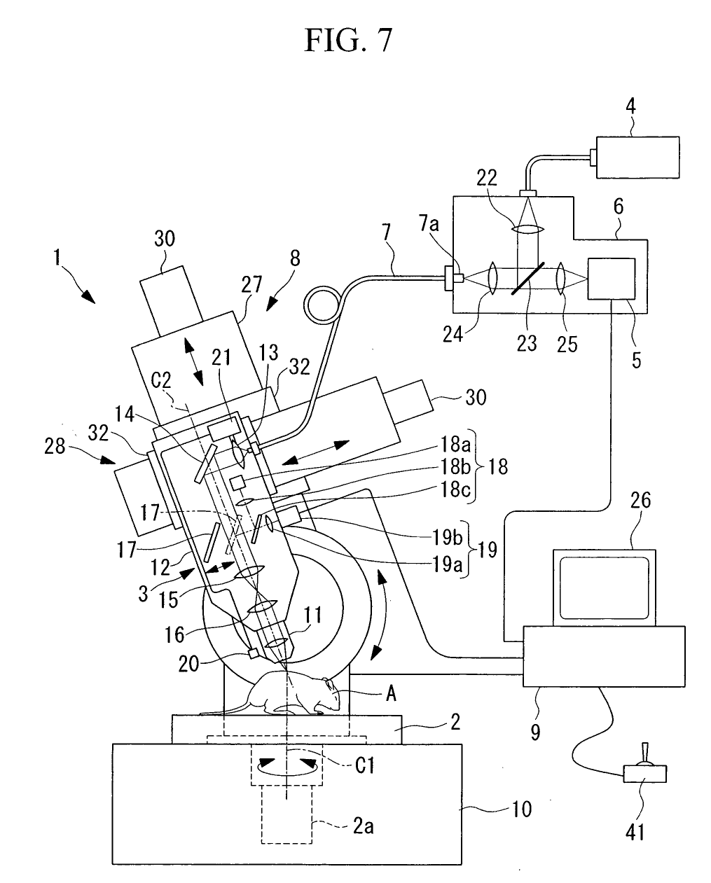

Instead of the control device 9 for automatically controlling the orientation adjusting mechanism 8, an examination apparatus 40 according to this embodiment includes a control device 42 having a manipulation device 41 for manually manipulating the orientation adjusting mechanism 8, as shown in FIG. 7. The manipulation device 41 is formed of any type of input device, such as a mouse, a joystick or the like.

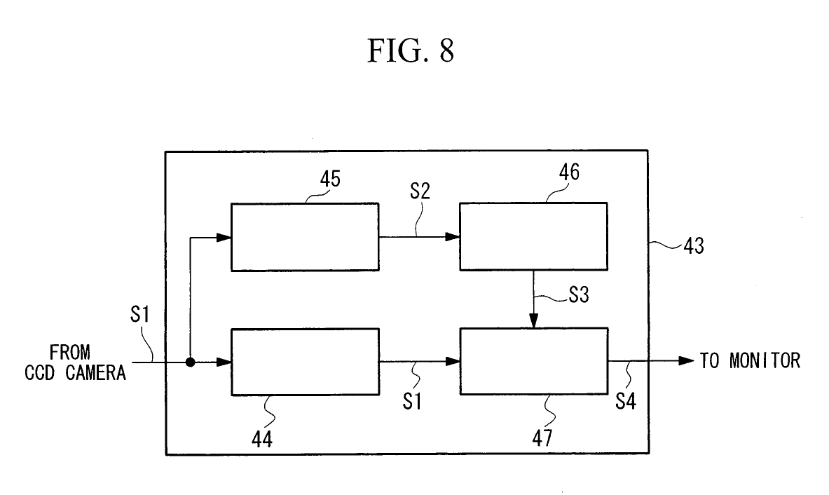

The manipulation device 42 includes an image processing unit 43 therein. As shown in FIG. 8, the image processing unit 43 includes an image storage unit 44 that stores image information S1 of the living organism A, which is acquired by the CCD camera 19b; a feature-point extraction unit 45 that processes the acquired image information S1 to extract a plurality of feature points P and outputs feature-point information S2; a motion-trajectory calculating unit 46 that calculates a motion trajectory Q of each feature point P extracted to output motion-trajectory information S3; and an image combining unit 47 that superimposes the image of the living organism A acquired by the CCD camera 19b and the calculated motion trajectory Q of each feature point P. An image signal S4 output from the image combining unit 47 of the image processing unit 43 is transmitted to the monitor 26 and is displayed.

The manipulation device 41 allows the optical axis C2 of the measurement head 3 to be moved in a desired angular direction.

With the examination apparatus 40 according to this embodiment, having such a configuration, as shown in FIG. 5, the image G acquired by the CCD camera 19b is displayed on the monitor 26 together with individual motion trajectories Q. An observer operates the manipulation device 41 while looking at the image on the monitor 26, which allows him or her to check changes in the motion trajectories Q on the image G on the monitor 26. It can be ascertained that, when the motion trajectory Q at the examination site B being observed on the image G on the monitor 26 is long, the optical axis C2 of the measurement head 3 is tilted with respect to the moving direction of the surface of the living organism A, and when the motion trajectory Q is short, the optical axis C2 of the measurement head 3 is in a direction close to the moving direction of the surface of the living organism A.

Therefore, the observer can adjust the orientation of the optical axis C2 of the measurement head 3 by operating the manipulation device 41 so that the motion trajectory Q on the image G on the monitor 26 becomes shorter.

By doing so, after the optical axis C2 of the measurement head 3 is disposed in a direction parallel to the displacement direction of the living organism A, examination is switched over to examination using the optical unit 6, and by carrying out examination, it is possible to acquire blur-free fluorescence images.

As described above, the conventional microscope photographing apparatus described in Japanese Unexamined Patent Application Publication No. 2000-275539 takes photographs according to the dynamic motion of a specimen; however, since it selectively takes pictures in a stationary, in-focus state during the dynamic motion of the specimen while keeping the focal length of the camera constant, the acquired images are choppy and, in particular, there is a drawback in that it is not possible to examine the condition of the specimen while it is moving.

Therefore, in order to acquire sharp images from a living organism that exhibits dynamic motion, a microscope examination system and a microscope examination method shown in the third embodiment and fourth embodiment are provided.

### Third Embodiment

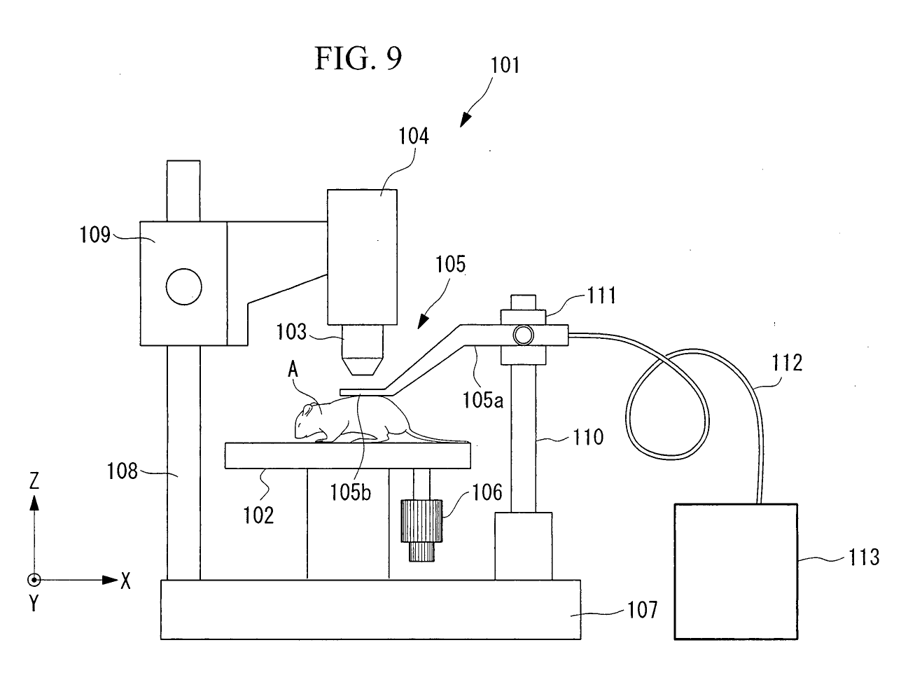

A microscope examination system and a microscope examination method according to a third embodiment of the present invention are described below with reference to FIGS. 9 to 11 and FIGS. 12A to 12C.

As shown in FIG. 9, a microscope examination system 101 according to this embodiment includes a stage 102 for mounting a specimen A, such as cellular or muscular biological tissue of a mammal, including small laboratory animals, or various organs, such as the heart, liver and so on; a microscope examination apparatus 104, disposed above the stage 102 and having an objective unit 103 which is disposed opposite the specimen A on the stage 102; and a stabilizer 105 disposed in the vicinity of the microscope examination apparatus 104.

The stage 102 includes an adjustment dial 106, which enables the specimen to be moved in two horizontal directions, for example, the X and Y directions, by operating the adjustment dial 106.

The microscope examination apparatus 104 is attached to a support stand 108 that extends in the vertical direction from a base 107 so as to be movable upwards and downwards by means of a raising and lowering mechanism 109. By disposing the objective unit 103 so as to point vertically downward, it is possible to examine the specimen A on the stage 102. Also, by operating the raising and lowering-mechanism 109, it is possible to bring the objective unit 103 closer to and further away from the specimen A to adjust the focus.

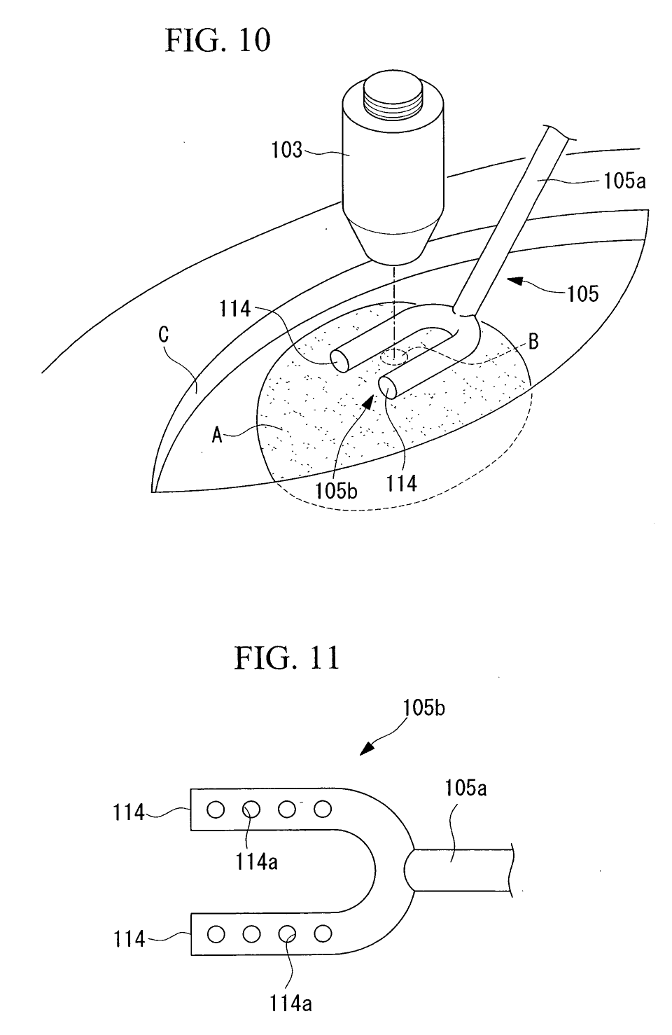

The stabilizer 105 includes an arm 105a that is attached to a support stand 110 extending in the vertical direction from the same base 107 so as to be movable upwards and downwards by means of a raising and lowering mechanism 111; a distal portion 105b that is disposed at the end of the arm 105a; and a suction pump 113 that sucks air via a tube 112 connected to the arm 105a. As shown in FIG. 10, the distal portion 105b includes two finger portions 114 that fork and extend from the arm 105a to substantially form a U-shape. The two finger portions 114 are disposed with a space therebetween that is larger than the objective unit 103, and an examination region B (the dotted line in the drawing) to be examined by the objective unit 103 is disposed between the two finger portions 114.

The arm 105a and the finger portions 114 are hollow structures. As shown in FIG. 111, a plurality of suction holes 114a are provided in the lower surface of the finger portions 114. When the suction pump 113 is operated, air sucked in from the suction holes 114a is sucked via the finger portions 114, the arm 105a, and the tube 112. In other words, by operating the suction pump 113 while the distal portion 105b is in contact with the specimen A so as to block all of the suction holes 114a in the lower surface of the finger portions 114, a low pressure state lower than atmospheric pressure is produced inside the finger portions 114, the arm 105a, and the tube 112, and the distal portion 105b and the specimen A are thus held together by suction.

The operation of the microscope examination system 101 according to this embodiment, having such a configuration, will be described below.

To examine the specimen A of a small laboratory animal and so on using the microscope examination system 101 according to this embodiment, first, as shown in FIG. 10, once the skin C of the small laboratory animal is incised to expose the specimen A such as an internal organ, the raising and lowering mechanism 111 is operated to lower the stabilizer 105 and bring the distal portion 105b of the stabilizer 105 into contact with the surface of the specimen A. Next, the suction pump 113 is operated to suck out air inside the tube 112 and the arm 105a, and the specimen A is thus held by the suction of the suction holes 114a. Then, in this state, the objective lens 103 of the microscope examination apparatus 104 is brought close to the examination region B disposed between the two finger portions 114 of the stabilizer 105, and examination is carried out with the microscope examination apparatus 104.

With the microscope examination system 101 according to this embodiment, dynamic motion of the surface of the specimen A held by suction by the stabilizer 105 is suppressed by means of the stabilizer 105. Therefore, the examination region B between the finger portions 114 whose dynamic motion is suppressed by the stabilizer 105 can be examined with the microscope examination apparatus 104, and it is thus possible to acquire clear, blur-free images.

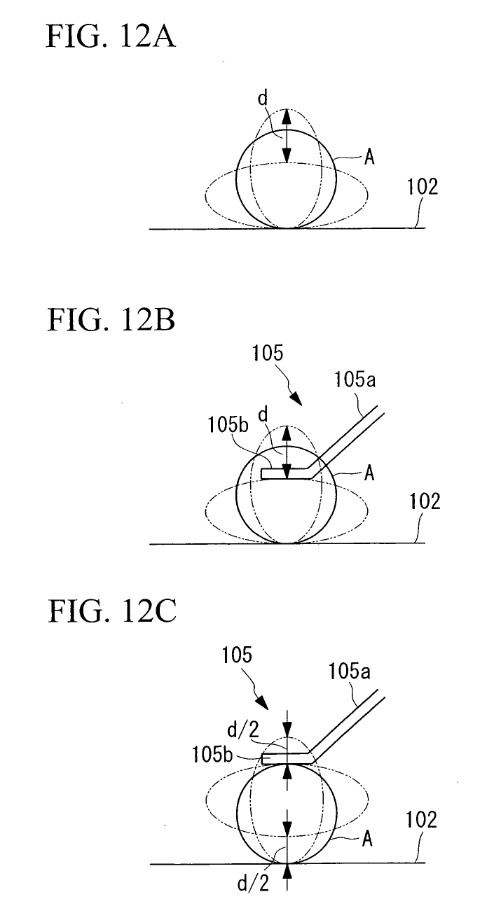

In such a case, in the microscope examination system 101 according to this embodiment, since the specimen A is held by suction by the suction holes 114a provided in the finger portions 114 of the distal portion 105b of the stabilizer 105 to suppress the dynamic motion thereof, an advantage is afforded in that an excessive strain is not exerted on the specimen A. More specifically, as shown in FIG. 12A, when the specimen A dynamically moves up and down within the range of an amount of motion d, in a case where the dynamic motion of the specimen A is suppressed simply by pressing the finger portions 114 of the stabilizer 105 against the surface of the specimen A, as shown in FIG. 12B, it is necessary to press the stabilizer 105 down to a point where the surface of the specimen A is at its lowest due to the dynamic motion. In this case, when the surface of the specimen A rises to its highest position, it is necessary to push in by the entire amount of motion d, which places an excessive strain on the specimen A. On the other hand, when the specimen A is held by suction by the stabilizer 105 of the present invention, as shown in FIG. 12C, since it is sufficient to push in by only ½ of the entire amount of motion d of the specimen A, it is possible to substantially reduce the stress placed on the specimen A.

Also, with the microscope examination system 101 according to this embodiment, since the finger portions 114 of the stabilizer 105 are disposed above the specimen A with a spacing therebetween that is slightly larger than the objective unit 103, the finger portions 114 can be prevented from entering the field of view of the objective unit 103, which allows a sufficiently large examination region B to be ensured. In addition, since the displacement of the specimen A is suppressed to within a position sufficiently close to the examination region B, image blurring can be effectively prevented.

Furthermore, with the microscope examination system 101 according to this embodiment, since the distal portion 105b is formed in a U shape and is disposed so as to surround the entire periphery of the examination region B, except for one part, it is possible to insert various instruments, such as a scalpel, a syringe, and so on, from the gap provided between the two finger portions 114 while continuing to suppress the dynamic motion of the specimen A by means of the stabilizer 105. In other words, it is also possible to use the stabilizer 105 for suppressing the dynamic motion during a procedure, rather than during microscope examination.

Furthermore, with the microscope examination system 101 according to this embodiment, since the stabilizer 105 for suppressing the dynamic motion of the specimen A is provided separately from the objective unit 103 of the microscope examination apparatus 104, it is possible to independently carry out preparation work in which the stabilizer 105 is disposed in contact with the specimen A and an examination operation using the microscope examination apparatus 104. Therefore, it is possible to carry out various procedures without the microscope examination apparatus 104 interfering in the preparation work.

The microscope examination system 101 according to the present invention is not limited to the embodiments described above; the configurations described below may also be employed.

Specifically, in the embodiments described above, the suction holes 114a are provided in the distal portion 105b of the stabilizer 105 and the specimen A is fixed by suction to reduce the strain on the specimen A. Instead of this, however, if the amount of motion d of the dynamic motion of the specimen A is relatively small, the dynamic motion of the specimen A may be suppressed merely with a pressing force, instead of providing the suction holes 114a.

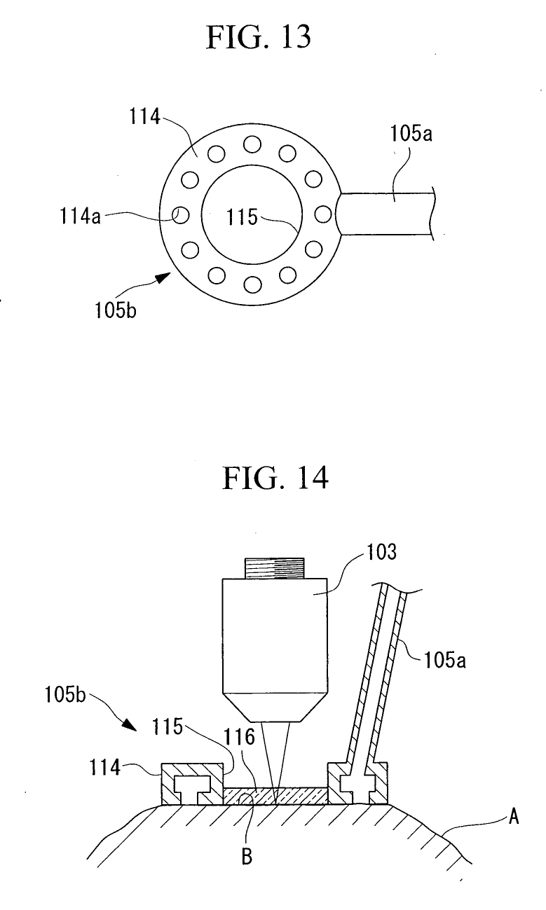

Also, although the distal portion 105b of the stabilizer 105 is formed in the shape of a letter U in the embodiment described above, instead of this, a ring-shaped distal portion 105b that completely surrounds the examination region B may be employed, as shown in FIG. 13. With this structure, it is possible to more reliably suppress the dynamic motion of the specimen A at the examination region B.

Furthermore, as shown in FIG. 14, a glass plate 116 that contacts the specimen A at the examination region B may be provided in an opening 115 provided at the examination region B in the distal portion 105b of the stabilizer 105. By doing so, the contact area between the stabilizer 105 and the specimen A is increased, which allows the force applied to the specimen A to be reduced, and therefore, it is possible to reduce the stress placed on the specimen A. Also, by brining the glass plate 116 into contact with the examination region B, it is possible to suppress even minute dynamic motion at the examination region B.

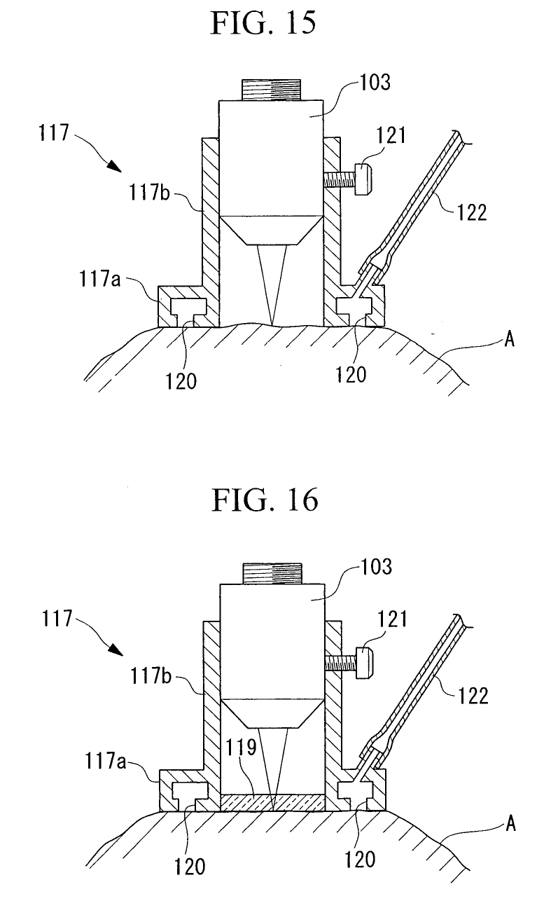

In the embodiment described above, the microscope examination apparatus 104 and the stabilizer 105 are independently attached to the respective separate support stands 108 and 110 so as to be capable of being raised and lowered; however, as shown in FIGS. 15 and 16, a stabilizer 117 may be formed in an integrated manner with the objective unit 103. FIG. 15 shows a case in which a glass plate 119 is not provided in an opening 118 of a distal portion 117a, and FIG. 16 shows a case in which the glass plate 119 is provided.

In these cases, it is preferable that the stabilizer 117 be constructed to have a tubular section 117b that fits to the cylindrical surface forming the outer surface of the objective unit 103 so as to be slidable along the axial direction thereof and the distal portion 117a including suction holes 120 disposed at the end thereof, that the tubular section 117b slide in the axial direction relative to the objective unit 103 to match the focal position of the objective unit 103, and be fixed integrally with the objective unit 103 by securing a locking screw 121. Reference numeral 122 is a tube connected to a suction pump for sucking the interior of the distal portion 117a to a produce a negative pressure.

With such a configuration, it is possible to adjust in advance the positional relationship between the objective unit 103 and the stabilizer 117 to match the focal position of the objective unit 103. Therefore, when the specimen A is held by suction to the distal portion 117a of the stabilizer 117, since the focal position of the objective unit 103 is aligned at the same time with the specimen A, the task of performing focusing for each examination can be omitted.

### Fourth Embodiment

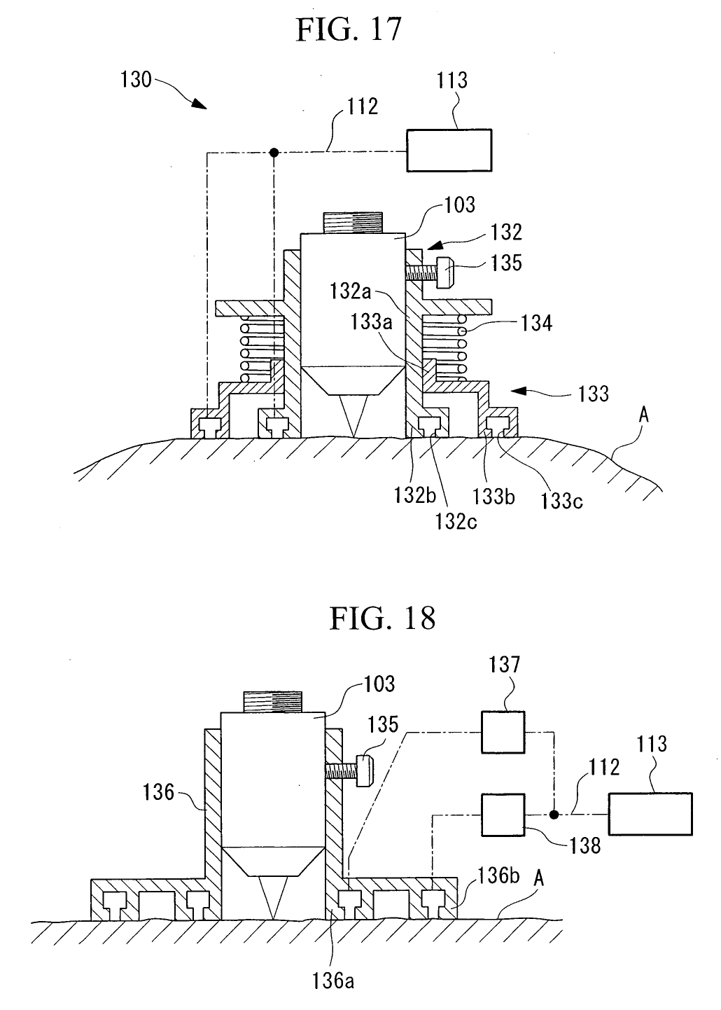

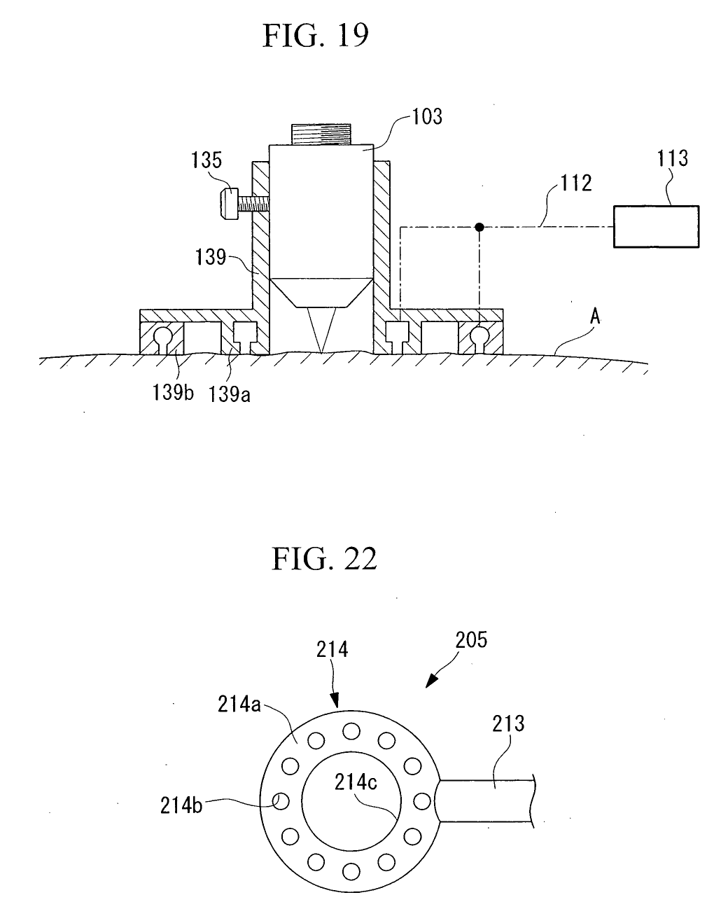

Next, a microscope examination system 130 according to a fourth embodiment of the present invention will be described with reference to FIG. 17.

In the description of this embodiment, parts having the same configuration as those in the microscope examination system 101 according to the third embodiment described above are assigned the same reference numerals, and a description thereof shall be omitted.

As shown in FIG. 17, the microscope examination system 130 according to this embodiment includes a stabilizer 131 of the type that is secured to the objective unit 103 of a microscope examination apparatus 104, and includes a first bracket 132 having a tubular part 132a that fits to the outer surface of the objective unit 103 so as to be slidable in the axial direction, a second bracket 133 having a tubular part 133a that fits to the outer surface of the first bracket 132 so as to be slidable in the axial direction, and a compression spring 134 disposed between the first and second brackets 132 and 133.

Distal portions 132b and 133b of the first and second brackets 132 and 133 are each formed in the shape of rings, and suction holes 132c and 133c are provided in respective end faces that are made to contact the specimen A. The provision of a negative pressure to the individual suction holes 132c and 133c is achieved by means of the same suction pump 113. That is, the suction forces with respect to the specimen A due to the distal portion 132b of the first bracket 132 and the distal portion 133b of the second bracket 133 are set to be substantially the same.

Also, a locking screw 135 is inserted into a threaded hole passing through the first bracket 132 in the radial direction. By disposing the tip of this locking screw 135 so as to be capable of pressing against the outer surface of the objective unit 103 and by fastening the locking screw 135, it is possible to fix the first bracket 132 at any position in the axial direction of the objective unit 103.

When the end faces of the distal portions 132b and 133b of the first bracket 132 and the second bracket 133 are disposed in substantially the same plane, the compression spring 134 is elastically deformed to a degree that produces a predetermined pressing force.

The operation of the microscope examination system 130 according to this embodiment, having such a configuration, will be described below.

When carrying out examination of the specimen A with the microscope examination system 130 according to this embodiment, first, the first bracket 132 is fitted to the outer surface of the objective unit 103, the first bracket 132 is slid in the axial direction to match the focal position of the objective unit 103, and the first bracket 132 is secured to the objective unit 103 by means of the locking screw 135.

Next, the distal portions 132b and 133b of the first bracket 132 and the second bracket 133, which are attached to the objective unit 103 in this way, are brought into contact with the surface of the specimen A. In this state, the suction pump 113 is operated so that the surface of the specimen A is held by suction by the distal portions 132b and 133b of the first and second brackets 132 and 133. Since the distal portion 132b of the first bracket 132 is set to match the focal position of the objective unit 103, when the first bracket 132 is brought into contact with the surface of the specimen A, the focal position of the objective unit 103 can accurately be aligned with the specimen A.

Then, since the surface of the specimen A is held by suction to the first bracket 132 which is secured to the objective unit 103, blur-free images of the specimen A are obtained by the microscope examination apparatus 104, even if the specimen A exhibits dynamic motion.

In this case, with the microscope examination system 130 according to this embodiment, the first bracket 132 and the second bracket 133 adhere to the specimen A with substantially the same suction force; however, in contrast to the fact that the first bracket 132 is secured to the objective unit 103, the second bracket 133 disposed thereabout is supported with a stiffness lower than that of the first bracket 132 by means of the compression spring 134 which is disposed therebetween. Therefore, if dynamic motion occurs in the specimen A, the first bracket 132 substantially completely suppresses the dynamic motion of the specimen A with the distal portion 132b thereof, but in contrast, the second bracket 133, by elastically deforming the compression spring 134, permits some dynamic motion. As a result, the dynamic motion of the specimen A is constrained by a constraining force that becomes progressively larger from the inner side to the outer side of the examination region B, which affords an advantage in that it is possible to lessen the strain placed on the specimen A compared to a case where the specimen is suddenly constrained by the single distal portion 105b, as in the third embodiment.

In this embodiment, the first bracket 132 and the second bracket 133 are connected via the compression spring 134 and the specimen A is held with substantially the same suction force. Instead of this, however, as shown in FIG. 18, ring-shaped distal portions 136a and 136b may be formed as a single piece securely supported on the outer face of the objective unit 103, and the respective suction forces at the distal portions 136a and 136b may be set so as to be different from each other by means of regulators 137 and 138. That is, it is preferable to set the suction force at the first distal portion 136a disposed at the inner side to be large and to set the suction force at the second distal portion 136b disposed at the outer side to be small.

With such a configuration, the constraining force of the dynamic motion of the specimen A due to the first distal portion 136a at the inner side is made large, and by permitting some dynamic motion by making the constraining force of the dynamic motion of the specimen A due to the second distal portion 136b at the outer side relatively smaller, it is possible for the constraining force to progressively increase towards the examination region B at the inner side, in the same way as described above. As a result, there is an advantage in that the strain applied to the specimen A due to a sudden change in the constraining force is reduced, which allows the burden placed on the specimen A to be reduced.

Furthermore, as shown in FIG. 18, the first distal portion 139a at the inner side may be formed of a hard material and the second distal portion 139b at the outer side of a comparatively flexible material, for example, rubber, and the specimen A may be held by suction by substantially equal suction forces. By doing so, it is possible to elastically deform the second distal portion 139b in a way that emulates the dynamic motion of the specimen A; by permitting some dynamic motion at the second distal portion 139b, while strongly suppressing the dynamic motion at the first distal portion 139a, which is disposed further inward, it is possible to achieve the same advantages as described above.

In the microscope examination system 101 according to the third embodiment, the specimen A is held by suction by means of the stabilizer 105 and the objective unit 103 is disposed with a predetermined gap from the specimen A. Instead of this, however, the specimen A may be sucked by the stabilizer 105 and the end face of the objective unit 103 may be pressed against the specimen A. Then, if the suction force of the stabilizer 105 is adjusted, the constraining force can be made to progressively increase from the outer side towards the examination region B.

In the study of biology, recently, visualization of ion concentration, membrane potential, and so on has been carried out based on fluoroscopy using optical microscopes; for example, so-called in-vivo examination, in which the whole body of a laboratory animal is used as a specimen and internal organs and so on are examined while the animal is still alive, has been performed. In in-vivo examination, since the object being examined exhibits motion such as a pulse or respiratory action, blurring or defocus of the examination site easily occurs.

As one method of removing such blurring or defocus of the examination site, an apparatus that makes an entire microscope provided with an imaging unit track the motion of the object being examined is known (see, for example, Japanese Unexamined Patent Application Publication No. 7-222754).

However, in the apparatus in Japanese Unexamined Patent Application Publication No. 7-222754, it is necessary to drive the entire microscope, including the imaging unit, which is extremely heavy. Therefore, there is a drawback in that it is not possible to drive it at high speed. For example, when examining a heart, the pulse rate of a rat is about 350 beats per second and the pulse rate of a mouse is about 620 beats per second, and it is extremely difficult to make the apparatus in Japanese Unexamined Patent Application Publication No. 7-222754 follow these pulse rates.

Therefore, in order to enable acquisition of clear images from a living organism that exhibits dynamic motion and that moves with a particularly short period, microscope examination systems shown in the fifth to eighth embodiments are provided.

### Fifth Embodiment

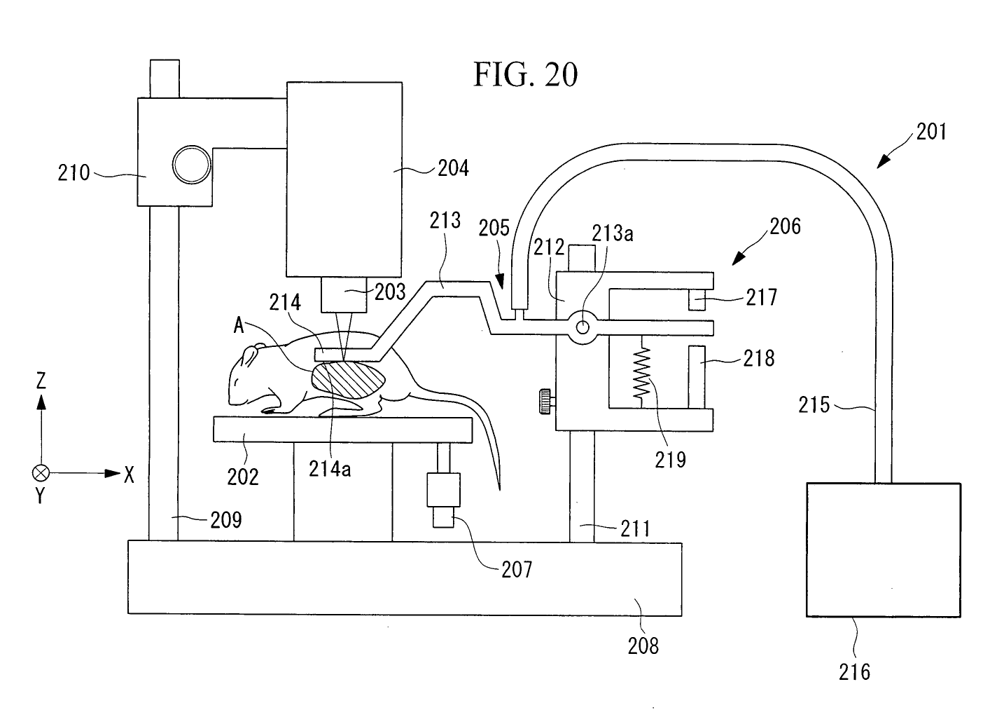

A microscope examination system according to a fifth embodiment of the present invention will be described below with reference to FIGS. 20 to 22.

As shown in FIG. 20, a microscope examination system 201 according to this embodiment includes a stage 202 for mounting a specimen A, such as cellular or muscular biological tissue of mammals, including small laboratory animals, or various organs, such as the heart, liver and so on; a microscope examination apparatus 204 including an objective unit 203 disposed opposite the specimen A on the stage 202 and having a predetermined focal depth; a stabilizer 205 disposed near the microscope examination apparatus 204; and a motion-restricting mechanism 206 for restricting the range of motion of the stabilizer 205.

The stage 202 includes an adjustment dial 207, which enables the specimen to be moved in two horizontal directions, for example, the X and Y directions, by operating the adjustment dial 207.

The microscope examination apparatus 204 is attached to a support stand 209 that extends in the vertical direction from a base 208 so as to be movable upwards and downwards by means of a raising and lowering mechanism 210. By disposing the objective unit 203 so as to point vertically downward, it is possible to examine the specimen A on the stage 202. Also, by operating the raising and lowering mechanism 210, it is possible to bring the objective unit 203 closer to and further away from the specimen A to adjust the focus.

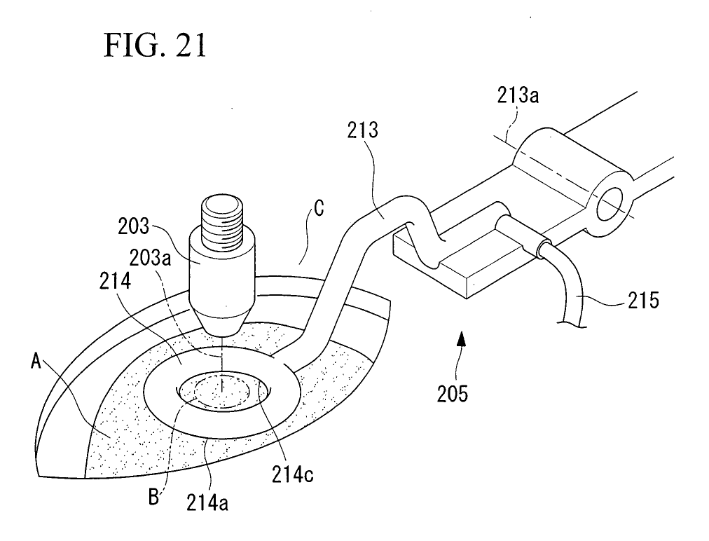

The stabilizer 205 is attached to a support stand 211 extending in the vertical direction from the same base 208 so as to be movable upwards and downwards by means of a raising and lowering mechanism 212. The stabilizer 205 is further attached to the raising and lowering mechanism 212 and includes a swinging arm 213 that is supported in a slidable manner about a horizontal axis 213a, that is, in a vertical plane, a suction pad 214 disposed at an end of the swinging arm 213, and a suction pump 216 that sucks out air via a tube 215 that is connected to the swinging arm 213. As shown in FIG. 21, the suction pad 214 is formed in a circular shape located vertically below a suction surface 214a. The suction pad 214 includes a central hole 214c which is larger than an examination region B (the dotted line in the drawing) of the objective unit 203, so as to prevent the entry of the suction pad 214 into the examination region B.

The swinging arm 213 and the suction pad 214 are hollow structures. As shown in FIG. 22, a plurality of suction holes 214a are provided in the suction surface 214a on the lower side of the suction head 214. Upon operating the suction pump 216, the air sucked in from the suction holes 214b is sucked out via the suction pad 214, the swinging arm 213, and the tube 215. In other words, by operating the suction pump 216 in a state where the suction pad 214 is in contact with the specimen A so as to block all of the suction holes 214b in the suction surface 214a, a low pressure lower than atmospheric pressure is produced inside the suction pad 214, the swinging arm 213, and the tube 215, and the specimen A is thus held against the suction surface 214a of the suction pad 214.

Also, as shown in FIG. 21, the swinging arm 213 of the stabilizer 205 is formed in a shape that curves to protrude vertically upwards from the suction pad 214 towards the center of rotation 213a.

The center of rotation 213a of the swinging arm 213 is disposed within a place extending from the suction surface 214a of the suction pad 214. Thus, the suction surface 214a of the suction pad 214 is disposed substantially orthogonal to an optical axis 203a of the objective unit 203. In this embodiment, the optical axis 203a of the objective unit 203 is disposed substantially vertically, and the suction surface 214a of the suction pad 214 is disposed substantially horizontally. Therefore, by swinging the swinging arm 213, the suction surface 214a of the suction pad 214 is displaced substantially vertically, that is to say, substantially in a straight line parallel to the direction of the optical axis 203a of the objective unit 203.

As shown in FIG. 20, the motion-restricting mechanism 206 is disposed in the raising and lowering mechanism 212, and includes stoppers 217 and 218 disposed so as to make contact with the end of the swinging arm 213 from above and below. The stoppers 217 and 218 are disposed with a gap therebetween in the vertical direction. The stoppers 217 and 218 define an upper-limit position and a lower-limit position of the swinging arm 213, and this upper-limit position and lower-limit position are set so that the suction surface 214a of the suction pad 214 is always located within the depth of focus of the objective unit 203.

In FIG. 20, reference numeral 219 is a balance spring for balancing the swinging arm 213.

The operation of the microscope examination system 201 according to this embodiment, having such configuration, will be described below.

To examine the specimen A of a small laboratory animal and so on using the microscope examination system 201 according to this embodiment, first, as shown in FIG. 21, once the skin C of the small laboratory animal is incised to expose the specimen A such as an internal organ, the raising and lowering mechanism 212 is operated to lower the stabilizer 205 and bring the suction surface 214a of the suction pad 214 of the stabilizer 205 into contact with the surface of the specimen A. Next, the suction pump 216 is operated to suck out air inside the tube 215 and the swinging arm 213, and the specimen A is thus held by the suction of the suction holes 214b. Then, in this state, by operating the raising and lowering mechanism 210, the objective unit 203 of the microscope examination apparatus 204 is brought close to the examination region B disposed inside the central hole 214c of the suction pad 214, and examination is carried out with the microscope examination apparatus 204.

With the microscope examination system 201 according to this embodiment, dynamic motion of the examination region B of the specimen A held by suction to the stabilizer 205 is suppressed by means of the stabilizer 205. That is, the suction surface 214a is made to contact the specimen A and the stabilizer 205 can be thus displaced together with the specimen A; however, since it is supported so as to be capable of swinging only about the horizontal axis 213a, only displacement of the specimen A in the direction of the optical axis 203a (the Z direction) of the objective unit 203 is permitted, while displacement in other directions (the X and Y directions) is constrained. Therefore, the specimen A is prevented from being shifting in a direction intersecting the optical axis 203a of the objective unit 203, and it is therefore possible to suppress blurring of the image.

In such a case, since the only mechanically movable part is the swinging arm 213, by forming the swinging arm 213 of a lightweight material, such as plastic, as well as reducing the strain placed on the specimen A, it is also possible to easily track the motion, even if the period of motion of the specimen A is short, thus allowing clear images to be acquired.

Furthermore, with the microscope examination system 201 according to this embodiment, since the suction pad 214 of the stabilizer 205 has the central hole 214c which is slightly larger than the examination region B of the objective unit 203, the suction pad 214 can be prevented from impinging on the examination region of the objective unit 203, which allows a sufficiently large examination region B to be ensured. In addition, since the motion of the specimen A is suppressed at a position sufficiently close to the examination region B, blurring of the images can be prevented effectively.

Moreover, with the microscope examination system 201 according to this embodiment, operating the motion-restricting mechanism 206 restricts the range of motion of the swinging arm 213, and accordingly, the position of the examination region B of the specimen A, which moves together with the suction pad 214, is restricted to within the depth of focus of the objective unit 203. Therefore, the images acquired by the microscope examination apparatus 204 are always in focus.

Since the swinging arm 213 is curved so as to protrude upwards in the microscope examination system 201 according to this embodiment, while positioning the center of rotation 213a of the swinging arm 213 in the same plane as the suction surface 214a, the swinging arm 213 can be positioned so as to be held by suction to the specimen A inside without interfering with the skin C, which has been incised.

In this way, with the microscope examination system 201 according to this embodiment, instead of completely constraining the motion of the specimen A, since only displacement in the direction of the optical axis 203a of the objective unit 203 is allowed, an advantage is afforded in that it is possible to carry out in-vivo examination of the specimen A in a more natural state, compared to a case where the motion is completely constrained.

Although a description has been given in which a circular member is used as the suction pad 214, instead of this, it is possible to employ a member with any shape, such as a U-shape.

Also, instead of the stoppers 217 and 218, at the position of the balance spring 219 which balances the swinging arm 213 in the horizontal state, it is possible to provide another motion-restricting mechanism (not shown in the drawing), such as a spring that exerts a force in a direction restricting the displacement according to the amount of displacement from the horizontal position of the swinging arm 213. By doing so, the amplitude of the motion of the specimen A is reduced, and it is thus possible to swing the swinging arm 213 in a range where it does not come into contact with the stoppers 217 and 218. By making contact with the stoppers 217 and 218, a sudden strain can be prevented from acting on the specimen A.

Furthermore, with the microscope examination system 201 according to the present invention, since the stabilizer 205 for restraining the dynamic motion of the specimen A is provided separately from the objective unit 203 of the microscope examination apparatus 204, it is possible to separately perform preparatory work where the stabilizer 205 is disposed in contact with the specimen A and an examination operation using the microscope examination apparatus 204. Therefore, it is possible to carry out various procedures in the preparatory operation without the microscope examination apparatus 204 causing any obstruction.

The microscope examination system 201 according to the present invention is not limited to the embodiment described above; the constructions described below can be employed.

Specifically, in the embodiment described above, the suction holes 214b are provided in the distal portion 205b of the stabilizer 205 to hold the specimen A by suction, thus reducing the strain placed on the specimen A. Instead of this, however, if the extent of the dynamic motion of the specimen A is comparatively small, the dynamic motion of the specimen A may be suppressed just by a pressing force, without providing the suction holes 214b.

Also, although a description has been given of a case in which the optical axis 203a of the objective unit 203 is disposed vertically, instead of this, the optical axis 203a may be disposed in any direction. In such a case, it is preferable that the suction surface of the suction pad 214, which includes the center of rotation 213a of the swinging arm, be disposed in a direction orthogonal to the optical axis 203a.

### Sixth Embodiment

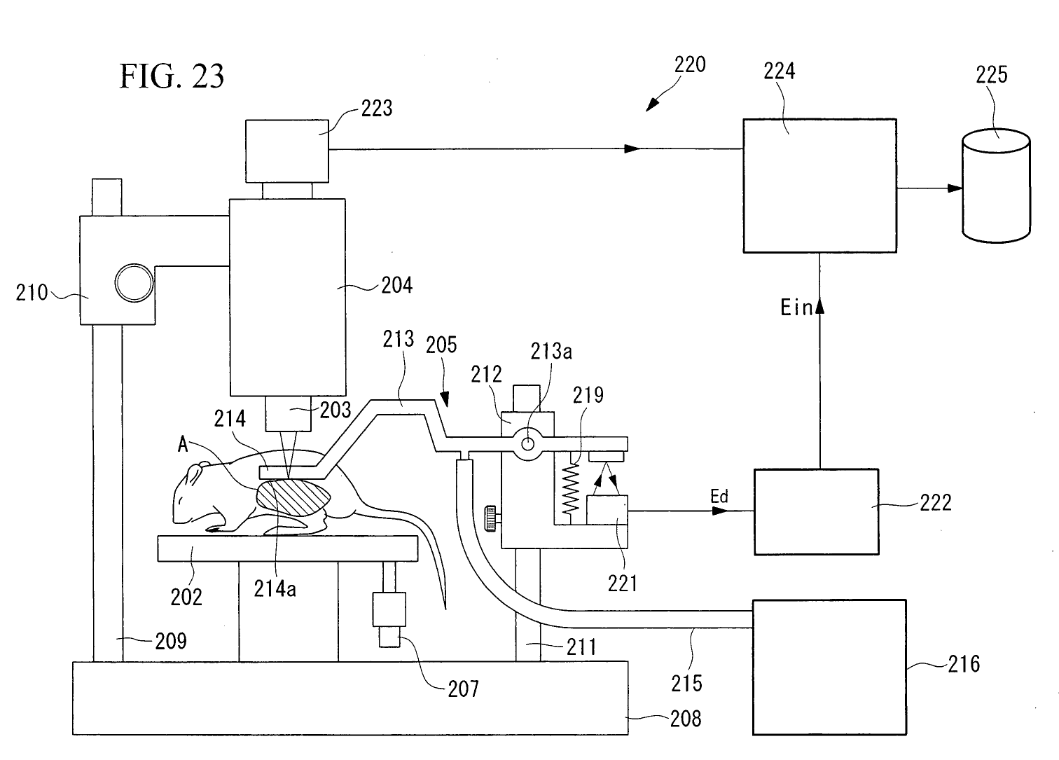

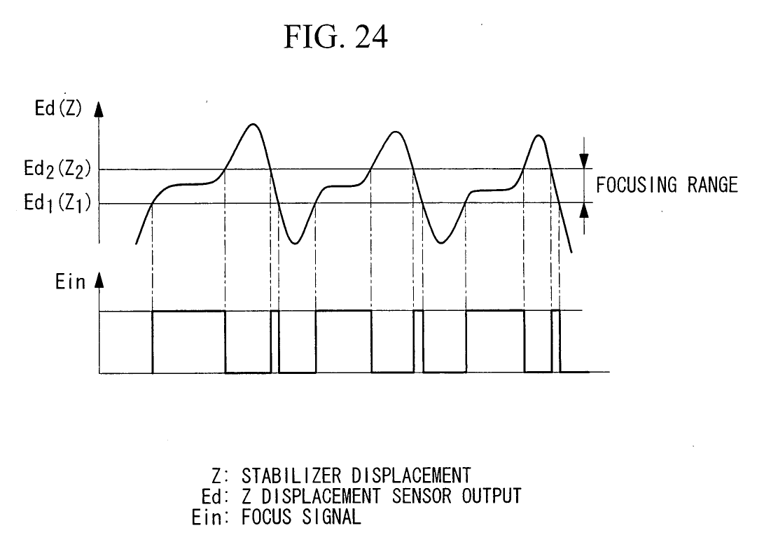

Next, a microscope examination system 220 according to a sixth embodiment of the present invention will be described below with reference to FIG. 23 and FIG. 24.

In the description of this embodiment, parts having the same configuration as those in the microscope examination system 201 according to the fifth embodiment described above are assigned the same reference numerals, and a description thereof shall be omitted.

As shown in FIG. 23, the microscope examination system 220 according to this embodiment includes, instead of the stoppers 217 and 218 of the microscope examination system 201 according to the fifth embodiment, a displacement sensor 221 that detects the amount of displacement of an end of the stabilizer 205; a focus-signal generating unit (focus-signal generating mechanism) 222 that generates a focus signal indicating whether the suction surface 214a of the suction pad 214 is within the depth of focus of the objective unit 203 on the basis of the displacement sensor 221; an image selection unit 224 (image selection mechanism) that selects an image, while the focus signal is being generated, from images transmitted from a CCD camera 223 provided in the microscope examination apparatus 204; and a frame memory 225 that stores the selected image.

The displacement sensor 221 is preferably a non-contact distance sensor, for example, of an optical type.

As shown in FIG. 24 for example, the focus-signal generating unit 222 generates a focus signal Ein when a displacement signal Ed that the displacement sensor 221 outputs is within a focusing range Ed1 to Ed2 and stops generating the focus signal Ein when it is outside this range.

With the microscope examination system 220 according to this embodiment, having such a configuration, similarly to the microscope examination system 201 of the fifth embodiment, only motion of the specimen A in the direction of the optical axis 203a of the objective unit 203 is permitted by the stabilizer 205, whereas motion in other directions is constrained, which allows image blurring to be prevented. Also, since the amount of displacement Ed of the specimen A is output while using the stabilizer 205 to constrain the motion of the specimen A, it is possible to perform stable detection, even if it is difficult to perform displacement detection of an object such as a small specimen having low reflectivity of light or low contrast with a regular optical device.

By operating the image selection unit 224, only images when the examination region B is within the focusing range of the objective unit 203 are selected from images acquired continuously or still images acquired at predetermined time intervals in the CCD camera 223 of the microscope examination apparatus 204 and are stored in the frame memory 225. Therefore, after this, defocused images are eliminated from the images read out from the frame memory 225 and examined, which provides an advantage in that it is possible to carry out examination using clear images.

In this embodiment, images in which the specimen A is within the focusing range of the objective unit are selected from among the images acquired continuously or over a predetermined period of time at predetermined time intervals by the CCD camera 223 of the microscope examination apparatus 204. Instead of this, however, the image-acquisition operation may be carried out by the CCD camera 223 only within a time period where the focus signal Ein is received from the focus-signal generating unit 222.

Furthermore, although only the images selected by the image selecting unit 224 are stored in the frame memory 225, instead of this, all images may be stored in association with the focus signal Ein. By doing so, an advantage is provided in that in-focus images can be selected later based on the focus signal Ein, and it is possible to carry out examination in full at a later stage, even if important images have some slight defocus.

### Seventh Embodiment

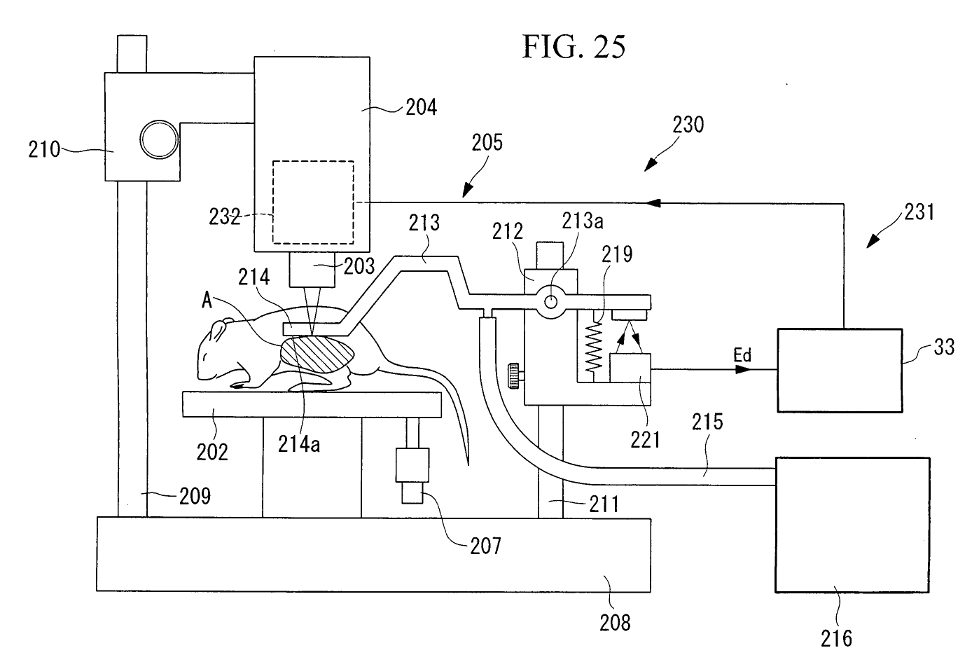

Next, a microscope examination system 230 according to a seventh embodiment of the present invention will be described with reference to FIG. 25.

In the description of this embodiment, parts having the same configuration as those in the microscope examination system 220 according to the sixth embodiment described above are assigned the same reference numerals, and a description thereof shall be omitted.

As shown in FIG. 25, the microscope examination system 230 according to this embodiment includes a focus servo mechanism 231 for adjusting the focus position of the objective unit 203 in the microscope examination apparatus 204 in the direction of the optical axis 203a. The focus servo mechanism 231 includes a control unit 233 that moves a servo mechanism 232 on the basis of the displacement signal Ed from the displacement sensor 221. The servo mechanism 232 is a linear motion mechanism that moves a lens in the direction of the optical axis 203a.

With the microscope examination system 230 according to this embodiment, having such a configuration, similarly to the microscope examination systems 201 and 220 according to the fifth and sixth embodiments, examination can be carried out while only displacement of the specimen A in the direction of the optical axis 203a of the objective unit 203 is permitted by the stabilizer 205, whereas displacement in other directions is constrained, which provides an advantage in that image blurring can be suppressed. Also, since the displacement Ein of the specimen A is detected while using the stabilizer 205 to constrain the motion of the specimen A, it is possible to perform more stable detection compared to a case where the surface of a specimen A that gleams due to bodily fluid, such as an internal organ, is directly detected.

Furthermore, since the focus position is adjusted in the direction of the optical axis 203a with the focus servo mechanism 231, displacement of the specimen A is permitted over a wider region, and it is possible to carry out examination in a focused state. Therefore, the specimen A can be restrained to a minimum, and the strain placed on the specimen A can be reduced.

### Eighth Embodiment

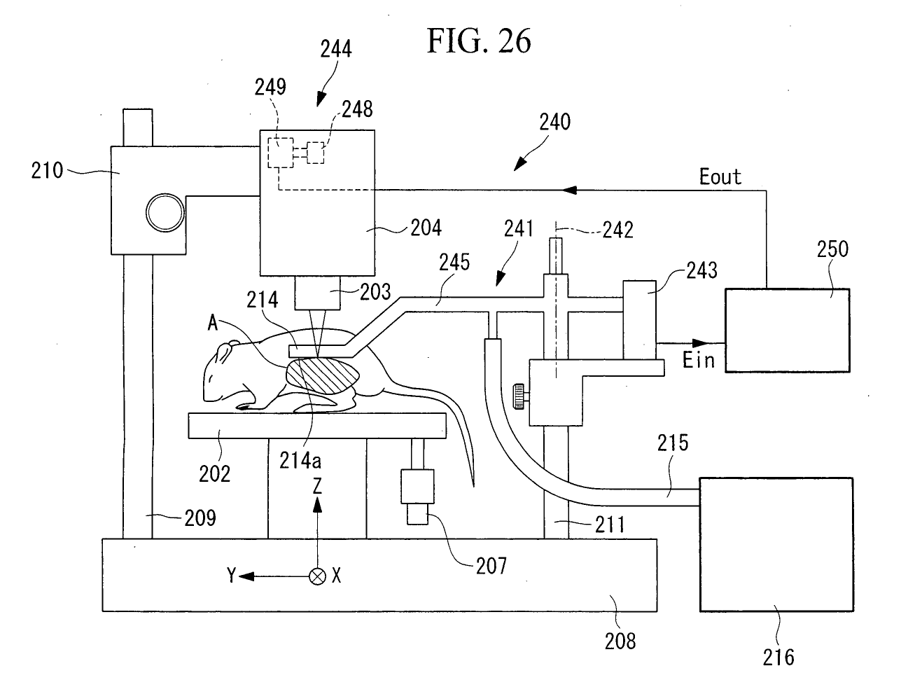

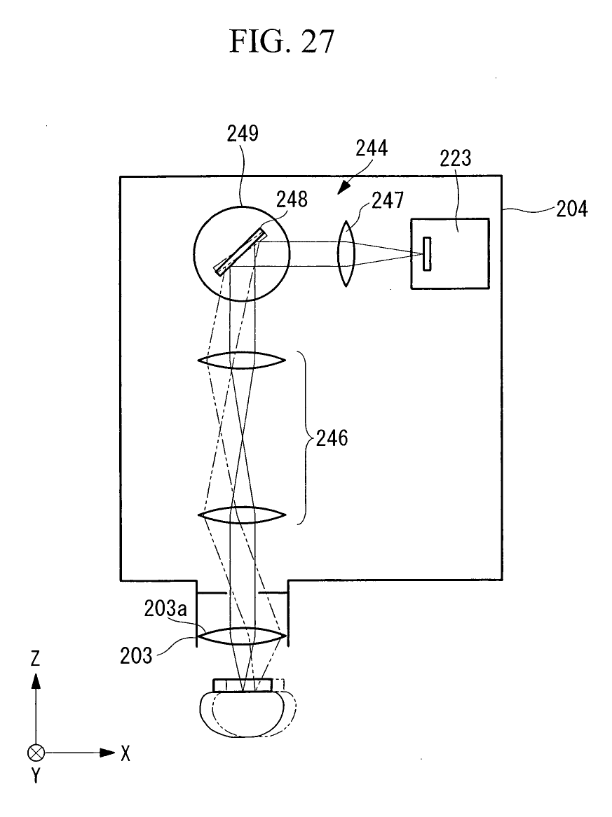

Next, a microscope examination system 240 according to an eighth embodiment of the present invention will be described below with reference to FIG. 26 and FIG. 27.

In the description of this embodiment, parts having the same configuration as those in the microscope examination system 230 according to the seventh embodiment described above are assigned the same reference numerals, and a description thereof shall be omitted.

As shown in FIG. 26, the microscope examination system 240 according to this embodiment differs from the microscope examination system 230 according to the seventh embodiment in that a stabilizer 241 is supported so as to be swingable about a vertical axis 242, that a displacement sensor 243 detects the horizontal displacement of an end of the stabilizer 241, and that the examination position is adjusted in a direction orthogonal to the optical axis 203a of the objective unit 203.

By supporting the stabilizer 241 so as to be swingable about the vertical axis 242, the specimen A is supported such that it can be constrained in the Y direction and the Z direction, whereas it can shift only in the X direction. In this embodiment, in which it is not necessary to rotate the stabilizer 241 in a vertical plane, the swinging arm 245 may have a shape that extends in the opposite direction with respect to the suction surface 214a in order to avoid interference with the skin C.

As shown in FIG. 27, the servo mechanism 244 is formed of a galvano mirror 248, which is disposed between a pupil relay lens 246 and an imaging lens 247, and a motor 249 which drives the galvano mirror 248. A control unit 250 is connected to the motor 249. The control unit 250 calculates an amount of displacement of the suction pad 214 in the X direction on the basis of an amount of displacement Ein of the end of the swinging arm 245 in the X direction, which is detected by a displacement sensor 243, and outputs a rotation-angle command Eout for the galvano mirror 248, which causes the position of the image to move in the X direction by that same amount.

The operation of the microscope examination system 240 according to this embodiment, having such a configuration, will be described.

With the microscope examination system 240 according to this embodiment, examination can be carried out while permitting only displacement of the specimen A in the X direction orthogonal to the direction of the optical axis 203a of the objective unit 203 by means of the stabilizer 241 and constraining the displacement in the other directions. Therefore, it is possible to always position the specimen A within the depth of focus of the objective unit 203, which allows in-focus images to be acquired.

Also, regarding the motion in the X direction, an image disposed at the central position of the examination region is described below using the example shown in FIG. 27. Light emitted from the image disposed at substantially the central position of the specimen A, as indicated by the solid line, is converted to a collimated beam by the objective lens 203a, and thereafter, forms an intermediate image with the pupil relay lens 246, goes back to a collimated beam, is reflected by the galvano mirror 248 and is imaged substantially at the center of the CCD camera 223 by the imaging lens 247.

If the specimen A is displaced from this state as indicated by the broken line, the motor 249 is driven by operating the control unit 250. Accordingly, by swinging the galvano mirror 248 as shown by the broken line, the light path from the galvano mirror 248 to specimen A can be shifted as shown by the broken line, with the light path from the galvano mirror 248 to the CCD camera 223 remaining as is. Therefore, by swinging the galvano mirror 248 so as to make the amount of displacement of the image position the same as the amount of displacement Ein of the specimen, it is possible to acquire substantially still images, regardless of the displacement of the specimen A. That is, by shifting the examination region in the X direction to make it the same as the displacement of the specimen A in the X direction, it is possible to prevent the image from becoming blurred in the X direction.

In this way, with the microscope examination system 240 according to this embodiment too, an advantage is afforded in that it is possible to acquire clear images that are always in focus and in which blurring is reduced.

Additional Items

Inventions with the following configurations are derived from the third to eighth embodiments described above.

(1) A microscope examination system comprising:

a microscope examination apparatus having an objective unit disposed close to a specimen; and

a stabilizer that is made to contact the specimen at least the region examined by the microscope examination apparatus.

In order to achieve the object described above, the present invention provides the following solutions.

With this configuration, even if the specimen dynamically moves, making the stabilizer contact the specimen suppresses motion in the examination region, which is disposed at the inner side of the stabilizer. Therefore, the change in relative distance between the objective unit and the specimen is reduced, which allows clear, blur-free images to be acquired by the microscope examination apparatus.

(2) A microscope examination apparatus according to item

(1), wherein the region where the stabilizer is made to contact is disposed towards the outer side in the radial direction of the objective unit.

By doing so, entry of the stabilizer into the examination region of the objective unit can be avoided, which allows a reduction in size of the examination region to be prevented.

(3) A microscope examination system according to item (1) or item (2) further comprising a suction mechanism that causes the stabilizer to be fixed by suction to a surface of the specimen.

By doing so, the stabilizer is fixed by suction to the surface of the specimen by operating the suction mechanism, and the dynamic motion of the specimen surface in the vicinity of the suction region is suppressed. Since it is possible to suppress the motion of the specimen surface without substantially increasing the pressing force applied to the specimen, it is possible to reduce the strain placed on the specimen.

(4) A microscope examination system according to one of item (1) to item (3), wherein a transparent member that contacts the specimen disposed in the examination region is provided in the stabilizer.

By causing the transparent member to make contact, the motion of the specimen surface disposed in the examination region is directly suppressed, which allows the surface of the specimen whose motion is suppressed to be examined by the objective unit via the transparent member.

(5) A microscope examination system according to one of item (1) to item (4) wherein the stabilizer is formed in the shape of a ring that surrounds the entire periphery of the examination region.

It is possible to restrain the entire periphery around the examination region with the stabilizer, which allows the dynamic motion of the examination region to be effectively suppressed.

(6) A microscope examination system according to one of item (1) to item (4) wherein the stabilizer is formed in a shape that surrounds the entire periphery of the examination region, except for one part.

Substantially the entire periphery of the examination region is restrained with the stabilizer, and in addition, via the part that is not restrained, it is possible to perform various procedures on the examination region using a instrument or the like from the outside.

(7) A microscope examination system according to one of item (1) to item (6) wherein the stabilizer is a separate unit from the microscope examination apparatus.

By making the stabilizer and the microscope examination apparatus separate units, it is possible to carry out a set-up operation of the stabilizer at the specimen surface independently of setting up the examination conditions for the microscope examination apparatus. In other words, when the dynamic motion of the specimen is suppressed by the stabilizer, after performing various procedures on the specimen, such as injecting a fluorescent dye, it is possible to carry out focus adjustment and so on with respect to the examination region of the microscope examination apparatus.

(8) A microscope examination system according to one of item (1) to item (6) wherein the stabilizer is provided as an integrated unit with the microscope examination apparatus.

By integrating the stabilizer and the microscope examination apparatus, adjustment that is carried out each time becomes unnecessary, which allows examination to be performed more quickly.

(9) A microscope examination system according to item (8) wherein the stabilizer is provided so as to be capable of relative positional adjustment in the optical-axis direction, relative to the objective unit; and

a fixing mechanism for fixing the relative position between the stabilizer and the objective unit is provided.

By adjusting the relative position of the stabilizer and the objective unit in the optical axis direction depending on the kind of objective unit to which the stabilizer is mounted, and operating the fixing mechanism in this state to fix both of them, it is possible set up the system such that the objective unit exactly focuses on the specimen. Accordingly, the stabilizer is combined with the microscope examination apparatus, and it is possible to rapidly carry out examination.

(10) A microscope examination system according to item (1), wherein the stabilizer includes a first stabilizer that is provided so as to be integrated with the microscope examination apparatus and a second stabilizer, disposed around the first stabilizer, that is provided separately from the microscope examination apparatus;

and including a suction unit that attaches the first and second stabilizers to the surface of the specimen by suction;

wherein the suction force of the second stabilizer is loser than the suction force of the first stabilizer.

By operating the suction unit of the first and second stabilizers to attach both stabilizers to the specimen by suction, the dynamic motion of the specimen is suppressed, which enables blur-free, detailed images to be acquired. In such a case, since the second stabilizer, which is disposed further in the periphery than the first stabilizer, is attached by suction to the specimen with a lower suction force, the constraining force on the specimen at the suction region of the second stabilizer is set to be smaller than that of the first stabilizer. As a result, the constraining force progressively increases from the outside towards the examination region, and while sufficiently reducing the dynamic motion of the examination region whose motion must be suppressed the most, it is possible to avoid excessively constraining the specimen in the periphery, which allows the strain placed on the specimen to be reduced.

(11) A microscope examination system according to item (1) wherein the stabilizer includes a first stabilizer that is provided so as to be integrated with the microscope examination apparatus and a second stabilizer, disposed around the first stabilizer, that is provided separately from the microscope examination apparatus; and

where the second stabilizer is supported with a rigidity lower than that of the first stabilizer.

By doing so, in the same manner as in the invention described above, the constraining force can be made to progressively increase from the outside towards the examination region, and while sufficiently reducing the dynamic motion of the examination region whose motion should be suppressed the most, it is possible to avoid excessively constraining the specimen in the periphery, which allows the strain placed on the specimen to be reduced.

(12) A microscope examination system according to item (1) wherein the stabilizer includes a first stabilizer that is provided so as to be integrated with the microscope examination apparatus and a second stabilizer, disposed surrounding the first stabilizer, that is provided separately from the microscope examination apparatus; and

wherein the second stabilizer is formed of an elastic material whose rigidity is lower than that of the first stabilizer.

By doing so, in the same manner as in the invention described above, the constraining force can be made to progressively increase from the outside towards the examination region, and while sufficiently reducing the dynamic motion of the examination region whose motion should be suppressed the most, it is possible to avoid excessively constraining the specimen in the periphery, which allows the strain placed on the specimen to be reduced.

(13) A microscope examination method comprising, when carrying out microscope examination with an objective unit that is disposed close to a specimen, contacting a stabilizer with the specimen at least in the periphery of an examination region.

With this configuration, since microscope examination is carried out in a state in which the periphery of the examination region of the specimen is restrained by the stabilizer, it is possible to acquire clear images of the specimen in which blurring is suppressed.

With the inventions described in item (1) to item (13), since microscope examination is carried out in a state in which the periphery of the examination region of the specimen is restrained by the stabilizer, it is possible to acquire clear images of the specimen in which blurring is suppressed. Also, an advantage is provided in that is it possible to carry out examination even during the dynamic motion instead of having to selectively carry out examination during stable states.

(14) A microscope examination system comprising:

a microscope examination apparatus including an objective unit that is disposed close to a specimen;

a stabilizer, placed in contact with the specimen, that permits motion of an examination region of the specimen along an optical-axis direction of the objective unit while constraining motion in other directions; and

a motion restricting unit that restricts the range of motion of the stabilizer to within the depth of focus of the objective unit.

With this configuration, by placing the stabilizer in contact with the specimen, motion other than motion of the examination region of the specimen parallel to the optical-axis direction is constrained. If the examination region of the specimen shifts in a direction intersecting the optical axis, the image is normally blurred; however, with the present invention, the examination region of the specimen is permitted to move only in the direction parallel to the optical-axis direction by the stabilizer. Therefore, blurring does not occur in the images acquired by the microscope examination apparatus.

In addition, since the range of motion of the stabilizer is restricted by operating the motion restricting unit and the position of the examination region is within the depth of focus of the objective unit, it is possible to keep the images acquired by the microscope examination apparatus constantly in focus.

(15) A microscope examination system comprising:

a microscope examination apparatus including an objective unit that is disposed close to a specimen;

a stabilizer, placed in contact with the specimen, that permits motion of an examination region of the specimen parallel to an optical-axis direction of the objective unit while constraining motion in other directions;

displacement-amount detecting unit that detects an amount of displacement of the stabilizer; and

a control device that causes images to be acquired in the microscope examination apparatus when a position of the examination region calculated on the basis of the amount of displacement of the stabilizer, which is detected by the displacement-amount detecting unit, is within a focusing range of the objective unit.

With this configuration, by placing the stabilizer in contact with the specimen, motion of the examination region of the specimen other than motion in the optical-axis direction is constrained. Therefore, it is possible to suppress blurring that occurs in the images acquired by the microscope examination apparatus. Then, by operating the displacement-amount detecting unit, the amount of displacement of the stabilizer is detected. Since the stabilizer is in contact with the specimen and is thus displaced together with the specimen, it is possible to easily calculate the position of the examination region of the specimen from the amount of displacement. Since image acquisition is performed by the microscope examination apparatus when the position of the examination region of the specimen, which is calculated by operating the control device, in-focus images are always acquired.

(16) A microscope examination system comprising:

a microscope examination apparatus including an objective unit that is disposed close to a specimen;

a stabilizer, placed in contact with the specimen, that permits motion of an examination region of the specimen parallel to an optical-axis direction of the objective unit while constraining motion in other directions;

a displacement-amount detecting unit that detects an amount of displacement of the stabilizer; and

an image selection device that selects images acquired by the microscope examination apparatus when a position of the examination region calculated on the basis of the displacement of the stabilizer, which is detected by the displacement-amount detection unit, is within a focusing range of the objective unit.

With this configuration, by placing the stabilizer in contact with the specimen, motion of the examination region of the specimen other than motion in the optical-axis direction is constrained. Although the microscope examination apparatus continues to acquire images of the examination region of the specimen regardless of the motion of the specimen, the position of the examination region is constantly calculated on the basis of the amount of displacement detected by the operation of the displacement-amount detecting unit, and the image selecting unit selects images when the calculated position of the examination region is within the focusing range of the objective unit. Therefore, the selected images are always in-focus.

(17) A microscope examination system comprising:

a microscope examination apparatus including an objective unit that is disposed close to a specimen;

a stabilizer, placed in contact with the specimen, that permits motion of an examination region of the specimen parallel to an optical-axis direction of the objective unit while constraining motion in other directions;

a displacement-amount detecting unit that detects an amount of displacement of the stabilizer; and

a focus-position control device that adjusts a focus position of the objective unit on the basis of a position of the examination region calculated on the basis of the amount of displacement of the stabilizer, which is detected by the displacement-amount detecting unit.

With this configuration, by placing the stabilizer in contact with the specimen, displacement of the specimen in a direction orthogonal to the optical axis is suppressed, and blurring in the images is thus reduced. Then, since the focus-position control device adjusts the focus position of the objective unit with the position of the examination region calculated on the basis of the amount of displacement of the stabilizer detected by the displacement-amount detecting unit, it is possible to constantly acquire in-focus images.

(18) A microscope examination system according to one of item (14) to item (17), wherein the stabilizer includes a suction pad having a suction surface for fixing to the specimen by suction, and a swinging arm that makes the suction pad rotate within a plane substantially orthogonal to the suction surface; and

wherein the center of rotation of the swinging arm is disposed within substantially the same plane as the suction surface.

By causing the swinging arm to rotate, the suction pad is displaced within a plane substantially orthogonal to the suction surface. By making the rotation plane of the suction pad coincident with the plane including the optical axis of the objective unit, it is possible to displace the suction pad in a direction parallel to the optical axis. In such a case, since the center of rotation of the swinging arm is disposed within substantially the same place as the suction surface, it is possible to displace the suction surface substantially in a straight line parallel to the optical axis of the objective unit if the amount of displacement is set to be sufficiently small with respect to the length of the swinging arm. Therefore, with respect to the specimen, which is held by suction to the suction surface, only displacement in the optical-axis direction of the objective unit is permitted, while constraining displacement in other directions, thus allowing blur-free images to be acquired.

(19) A microscope examination system according to item (18) wherein the swinging arm is curved to protrude in the opposite direction from the suction surface of the suction pad.

If the specimen is disposed inside the skin, such as an internal organ of a small laboratory animal or the like, the skin is incised to insert the stabilizer inside the skin, and the suction pad is held by suction to the internal organ. In such a case, since the swinging arm is curved so as to protrude in the opposite direction from the suction surface of the suction pad, it is possible to position the swinging arm so that it is exposed from the incision in the skin when the suction pad is held by suction to the internal organ.

Therefore, interference with the skin is reduced, and it is possible to permit displacement of the specimen in the optical-axis direction.

(20) A microscope examination system comprising:

a microscope examination apparatus including an objective unit that is disposed close to a specimen;

a stabilizer, placed in contact with the specimen, that permits motion of an examination region of the specimen along a direction orthogonal to an optical-axis direction of the objective unit while constraining motion in other directions;

a displacement-amount detecting unit that detects an amount of displacement of the stabilizer; and

an examination-position control device that adjusts an examination position along a direction orthogonal to the optical-axis direction on the basis of a position of the examination region calculated on the basis of the amount of displacement of the stabilizer, which is detected by the displacement-amount detecting unit.

With this configuration, by placing the stabilizer in contact with the specimen, motion of the examination region of the specimen other than motion in a direction orthogonal to the optical-axis direction is constrained. Accordingly, it is possible to suppress defocusing occurring in the images acquired by the microscope examination apparatus. Then, the amount of displacement of the stabilizer is detected by operating the displacement-amount detecting unit, and, by operating the examination-position control device, the examination position of the objective unit is adjusted in a direction orthogonal to the optical axis on the basis of the position of the examination region of the specimen calculated on the basis thereof.

With the inventions described in item (14) to item (20), since the mechanically movable part is only the stabilizer or the stabilizer and part of an optical element, it is possible to easily track the motion of the specimen, even if the period is short, and to acquire clear images. Also, since microscope examination is carried out in a state the motion of the specimen is permitted in one direction by the stabilizer placed in contact with the specimen while restraining motion in other directions, it is possible to reduce the strain placed on the specimen during examination. Therefore, when carrying out in-vivo examination of the specimen, it is possible to examine it in a state closer to a natural state, compared to examining it in a completely constrained state. In addition, by adjusting the focal position of the objective unit relative to the permitted motion direction, it is possible to acquire clear, in-focus images in which blurring is suppressed. Furthermore, instead of selectively carrying out examination in stable states, an advantage is provided in that it is possible to carry out examination even in the presence of dynamic motion.

1-18. (canceled)

19. A microscope examination system comprising:
a microscope examination apparatus having an objective unit disposed close to a specimen;
a stabilizer, that is made to contact with the specimen, that permits motion of an examination region of the specimen parallel to an optical-axis direction of the objection unit while constraining motion in other directions;
a displacement-amount detecting unit that detects an amount of displacement of the stabilizer; and
a focus-position control device that adjusts a focus position of the objective unit on the basis of a position of the examination region calculated on the basis of the amount of displacement of the stabilizer, which is detected by the displacement-amount detecting unit.

20. A microscope examination according to claim 19, wherein the stabilizer includes a suction pad having a suction surface for fixing to the specimen by suction, and a swinging arm that makes the suction pad rotate within a place substantially orthogonal to the suction surface; and
wherein the center of rotation of the swinging arm is disposed within substantially the same plane as the suction surface.

21. A microscope examination system according to claim 20, wherein the swinging arm is curved to protrude in the opposite direction from the suction surface of the suction pad.
